(19) United States
(12) Patent Application Publication
(10) Pub. No.: US 2011/0287224 A1
(43) Pub. Date: Nov. 24, 2011

(54) METHOD FOR PRODUCING RETARDATION FILM, OPTICAL FILM, IMAGE DISPLAY DEVICE, LIQUID CRYSTAL DISPLAY DEVICE, AND RETARDATION FILM

(75) Inventors: Fumiaki Shirafuji, Shiga (JP); Haruhiko Maki, Shiga (JP); Kenji Ueshima, Shiga (JP); Sadao Fujii, Hyogo (JP); Takashi Taniguchi, Shiga (JP); Toshiyuki Iida, Osaka (JP); Motoko Kawasaki, Osaka (JP); Nao Murakami, Osaka (JP)

(73) Assignees: NITTO DENKO CORPORATION, Ibaraki-shi, Osaka (JP); KANEKA CORPORATION, Osaka-shi, Osaka (JP)

(21) Appl. No.: 13/145,039

(22) PCT Filed: Jan. 15, 2010
(86) PCT No.: PCT/JP2010/050388

§ 371 Date: Jul. 18, 2011

(30) Foreign Application Priority Data
Jan. 19, 2009 (JP) 2009-008857
Jul. 7, 2009 (JP) 2009-160656

(51) Int. Cl. B32B 3/00; B29C 43/24

(52) U.S. Cl. 428/156; 264/168

(57) ABSTRACT

It is an object to provide a method for producing a retardation film and the like, the retardation film contributing to cost reduction and enlargement of the screen of liquid crystal display devices having a high level of visibility.

There is provided a method for producing a retardation film, the method including conveying a long polymer film being continuously fed in a conveying direction while holding both side edges of the polymer film and stretching the polymer film in a direction transverse to the conveying direction while conveying the polymer film, wherein the retardation film has an optical axis in the direction transverse to the conveying direction of the polymer film and has optical properties satisfying 0.1≦NZ≦0.9, and wherein the polymer film is stretched in the transverse direction with sagged in the conveying direction.

### TECHNICAL FIELD

The present invention relates to a method for producing a retardation film. The present invention relates particularly to a method for producing a retardation film whereby a retardation film having an optical axis in a transverse direction being perpendicular to a conveying direction of a film and being excellent in optical properties is produced and to the like.

### BACKGROUND ART

Liquid crystal display devices represented by monitors (displays) for personal computers and television receivers are in widespread use as various display means. In order to improve visibility lowered due to lowered contrast and varied color when a display is viewed from different angles, especially when tilted, improvement of liquid crystal cells such as an IPS mode and a VA mode has been proposed (see Patent Document 1 and Patent Document 2).

Generally, there is provided a polarizer arranged at both sides of these liquid crystal cells, and it is known that further provision of a retardation film between a liquid crystal cell and a polarizer largely improves visibility of a display. It has been confirmed that, in particular, the use of a retardation film having an NZ value, which is an index of optical properties of a retardation film, within a range of 0.1 to 0.9 (0.1≦NZ≦0.9) by laminating the film so that its optical axis becomes perpendicular to an absorption axis of a polarizer considerably improves visibility of a display (see Patent Document 3). The NZ value as referred to herein is defined as below.

NZ=(nx−nz)/(nx−ny)

[“nx” indicates the refractive index in a direction of slow axis of a retardation film, in which the direction of slow axis means a direction having the largest refractive index in a retardation film plane, while “ny” indicates the refractive index in a direction of fast axis of the retardation film, and while “nz indicates the refractive index in a direction of thickness of the retardation film.]

Furthermore, a method for producing a retardation film having the NZ value within the range of 0.1≦NZ≦0.9 by utilizing a thermal shrinkable film has been proposed (see Patent Document 4).

### PRIOR ART

### Patent Document

Patent Document 1: JP 2001-311948 A
Patent Document 2: JP 11-305217 A
Patent Document 3: JP 2008-247933 A
Patent Document 4: JP 2006-72309 A

### DISCLOSURE OF INVENTION

### Technical Problem

In association with the enlargement of the screen of liquid crystal display devices, required qualities of retardation films to be used for improvement in visibility of liquid crystal display devices have been becoming higher rapidly. In particular, it has been required that the accuracy of an optical axis and a variance of retardation are good throughout a large area of films.

In order for liquid crystal display devices to spread widely in the world, revolutionary cost reduction of components to be used for liquid crystal display devices, that is, revolution of the structure, the material, the way of preparation, the supply, and the like of such components, and increase in productivity by standardization are needed.

As described above, the use of a retardation film by laminating the film so that its optical axis becomes perpendicular to an absorption axis of a polarizer considerably improves visibility of a display. A polarizer is manufactured normally by longitudinal and uniaxial stretching so as to have an absorption axis in a conveying direction of a film because the polarizer needs to stretch by three to seven times for expressing polarization properties.

In contrast, a retardation film to be laminated on a polarizer is preferably manufactured by transverse stretching by which the film has an optical axis in a direction transverse to a conveying direction of the film because it is ideal to make the film to have the optical axis in a transverse direction being perpendicular to the conveying direction. The retardation film manufactured by transverse stretching is considered to considerably reduce manufacturing cost because allowing roll to roll lamination with a polarizer. Besides, the retardation film increases in width by manufacturing the film by transverse stretching, so as to respond to the enlargement of the screen.

However, no material for a retardation film having the NZ value within the range of 0.1≦NZ≦0.9 that considerably improves visibility of a display and the optical axis in the stretching direction by transverse stretching has been found. Furthermore, a method for producing a retardation film having the NZ value within the range of 0.1≦NZ≦0.9 by utilizing a thermal shrinkable film as described above (see Patent Document 4) has been proposed, but the transverse stretching fails to shrink a thermal shrinkable film because the both side edges of the film is held with holding members. Therefore, it is impossible to obtain such a retardation film having the value within the range of 0.1≦NZ≦0.9 by this method.

Hence, it has been desired to achieve techniques to obtain a retardation film having an NZ value within a range of 0.1≦NZ≦0.9 that improves visibility of liquid crystal display devices and an optical axis in a transverse direction at low cost and largely in width.

### Solution to Problem

In view of the above-mentioned problems, the present inventors studied earnestly and found that a method for producing a retardation film described below and the like achieve the above-mentioned object, and led to have accomplished the present invention. The present invention is as follows.

An aspect of the present invention is a method for producing a retardation film, the method including conveying a long polymer film being continuously fed in a conveying direction while holding both side edges of the polymer film, and stretching the polymer film in a transverse direction being perpendicular to the conveying direction while conveying the polymer film,

wherein the retardation film has an optical axis in the transverse direction perpendicular to the conveying direction of the polymer film and has optical properties satisfying the following formula (1):

0.1≦NZ≦0.9 (1),

[NZ=(nx−nz)/(nx−ny), and

“nx” indicates the refractive index in a direction of slow axis of the retardation film, in which the direction of slow axis means a direction having the largest refractive index in a retardation film plane, while “ny” indicates the refractive index in a direction of fast axis of the retardation film, and while “nz” indicates the refractive index in a direction of thickness of the retardation film.], and

wherein the polymer film is stretched in the transverse direction with sagged in the conveying direction.

Preferably, the retardation film has an in-plane retardation (Re) with respect to light of a wavelength of 590 nm satisfying the following formula (2):

40 nm≦Re≦2000 nm (2),

[Re=(nx−ny)×d, and

“d (nm) indicates a thickness of the retardation film and “nx” and “ny” indicate the same meanings as those of the above-mentioned formula (1).].

Preferably, the retardation film has the optical axis in the retardation film plane within ±1.0°.

Preferably, the method includes a step of sagging the both side edges of the polymer film with members having projections and recesses and a stretching step of stretching the sagged polymer film in the transverse direction.

Preferably, the method further includes a holding step of holding the both side edges of the sagged polymer film on a conveyor, and in the stretching step, the polymer film is increased in width in the direction transverse to the conveying direction while being conveyed by the conveyor.

Preferably, the method starts to stretch the polymer film in the transverse direction with a partial area or the whole area of the polymer film sagged in the conveying direction while the both side edges of the polymer film are held with holding members provided with holding member pieces having projections and recesses.

Preferably, the method starts to stretch the polymer film in the transverse direction with a partial area or the whole area of the polymer film sagged by pushing one face and the other face of the polymer film in an alternate arrangement.

Preferably, the polymer film is made of a thermoplastic resin having 0.001 or more of a birefringence rate (Δn) in free-end uniaxial stretching at a stretch ratio of 2.0 under the condition of (Tg+10)° C. (herein “Tg” denotes a glass-transition temperature (° C.) of the polymer film.).

Preferably, the polymer film is laminated with a thermal shrinkable film at either one face or each face of the polymer film.

Preferably, the thermal shrinkable film is peeled after stretching of the polymer film in the transverse direction.

Another aspect of the present invention is an optical film being formed by laminating a polarizer directly or with a polarizer protection film on at least one face of the retardation film produced by the above-mentioned method.

Still another aspect of the present invention is an image display device including either the retardation film produced by the above-mentioned method or the optical film formed as described above.

Yet another aspect of the present invention is a liquid crystal display device including the optical film formed as described above.

Yet still another aspect of the present invention is a retardation film having an optical axis in a transverse direction perpendicular to a conveying direction of the film and optical properties satisfying the following formula (1):

0.1≦NZ≦0.9 (1),

[NZ=(nx−nz)/(nx−ny), and

“nx” indicates the refractive index in a direction of slow axis of the retardation film, in which the direction of slow axis means a direction having the largest refractive index in a retardation film plane, while “ny” indicates the refractive index in a direction of fast axis of the retardation film, and while “nz” indicates the refractive index in a direction of thickness of the retardation film.].

Preferably, the retardation film has an in-plane retardation (Re) with respect to light of a wavelength of 590 nm, wherein the in-plane retardation (Re) satisfies the following formula (2):

40 nm≦Re≦2000 (2),

[Re=(nx−ny)×d, and

“d (nm)” indicates a thickness of the retardation film and “nx” and “ny” indicate the same meanings as those of the above-mentioned formula (1).].

Preferably, the in-plane retardation (Re) satisfies the following formula (3):

100 nm≦Re≦350 (3).

Preferably, the in-plane retardation (Re) satisfies the following formula (4):

400 nm≦Re≦700 (4).

Preferably, the optical axis in the retardation film plane is within ±1.0°.

### Advantageous Effect of Invention

The method for producing a retardation film in the present invention ensures to provide a retardation film having an optical axis in a transverse direction and an NZ value that improves visibility when the film is employed in devices such as a liquid crystal display device at low cost and largely in width. As a consequence, it is possible to reduce the cost and to enlarge the screen of liquid crystal display devices having a high level of visibility.

The same can be said to the optical film in the present invention, which enables to reduce the cost and to enlarge the screen of liquid crystal display devices having a high level of visibility.

The image display device in the present invention has a high level of visibility and is easy to reduce the cost and to enlarge the screen.

The liquid crystal display device in the present invention has a high level of visibility and is easy to reduce the cost and to enlarge the screen.

The retardation film in the present invention has an optical axis in a transverse direction and an NZ value that improves visibility when the film is employed in devices such as a liquid crystal display device, and is excellent in optical properties. Further, the retardation film ensures the reduced producing cost and easy production of the film being large in width.

### BRIEF DESCRIPTION OF DRAWINGS

FIG. 1A is a plan view of an example of a film stretching machine available for a method for producing a retardation film of the present invention.

FIG. 2 is an explanatory diagram schematically showing a polymer film stretched in a transverse direction with sagged in a conveying direction.

FIG. 3 is a plan view of another example of a film stretching machine available for the method for producing a retardation film of the present invention.

FIG. 4A is a side view of an example of a clip (the broken line indicates corrugated gripping members), and FIG. 4B is an explanatory diagram showing the relationship between the clip in FIG. 4A and a film.

FIG. 5A is a side view of another example of a clip (the broken line indicates corrugated gripping members), and FIG. 5B is an explanatory diagram showing the relationship between the clip in FIG. 5A and a film.

FIG. 6 is a side view of feeder chains and corrugated gripping members.

FIG. 7 is a partially enlarged side view of the feeder chains and the corrugated gripping members in FIG. 6.

FIG. 8 is a perspective view of the film stretching machine in FIG. 3.

FIG. 9 is a front view of the clip and the corrugated gripping members.

FIG. 10 is a perspective view of the gripping members.

FIG. 11 is a front view of a modification example of members having projections and recesses.

FIG. 12 is a perspective view of another modification example of members having projections and recesses.

FIG. 13 a side view illustrating a modification example of feeder chains and corrugated gripping members.

FIGS. 14A and 14B show contrast cones of retardation films, FIG. 14A being of the film in Example 1-5 and FIG. 14B being of the film in Comparative example 1-3.

### BEST MODE FOR CARRYING OUT THE INVENTION

Now, embodiments of the present invention will be described in detail below, but the present invention is not limited thereto.

The present invention relates to a method for producing a retardation film, the retardation film having optical properties satisfying the following formula (1):

0.1≦NZ≦0.9 (1),

[NZ=(nx−nz)/(nx−ny), and

“nx” indicates the refractive index in a direction of slow axis of the retardation film, in which the direction of slow axis means a direction having the largest refractive index in a retardation film plane, while “ny” indicates the refractive index in a direction of fast axis of the retardation film, and while “nz” indicates the refractive index in a direction of thickness of the retardation film.]. The method conveys a long polymer film continuously fed in a conveying direction while holding both side edges of the polymer film and stretches the polymer film in a transverse direction perpendicular to the conveying direction while conveying the polymer film. Further, in the method in the present invention, the polymer film is stretched in the transverse direction with sagged in the conveying direction.

In the method in this invention, a long polymer film is used. The polymer film is made of raw resin selected accordingly and appropriately for any purpose. Specific examples of the resins include polycarbonate-based resins, norbornene-based resins, polyolefin-based resins, cellulose-based resins, urethane-based resins, styrene-based resins, polyvinyl chloride-based resins, acrylonitrile styrene-based resins, polymethylmethacrylate, polyvinyl acetate, polyvinylidene chloride-based resins, acrylonitrile butadiene styrene-based resins, polyamide-based resins, polyacetal-based resins, modified polyphenylene ether-based resins, polybutylene terephthalate-based resins, polyethylene terephthalate-based resins, polyphenylene sulfide-based resins, polysulfone-based resins, polyether sulfone-based resins, polyether ether ketone-based resins, polyarylate-based resins, liquid-crystalline resins, polyamide-imide-based resins, polyimide-based resins, and polytetrafluoroethylene-based resins. In particular, polycarbonate-based resins, norbornene-based resins, polyolefin-based resins, cellulose-based resins, urethane-based resins, styrene-based resins, polyimide-based resins, and polyamide-based resins are preferable because those resins each are effective in optical properties and strength when being formed into a film. These raw resins may be used as single agent or in combination of more than one agent. Further, these raw resins may be used after desired and appropriate polymer modification. The polymer modification includes copolymerization, cross-linkage, modification of molecular end, and modification of stereoregularity.

The polymer film can be shaped and obtained by various ways, for example, such as a casting method, by which a resin is dissolved into an organic solvent so as to be casted on a supporting body and then dried by heating so as to be formed into a film, and an extrusion molding method, by which a resin is fused and extruded from a T-die and the like so as to be formed into a film. Still further, it is possible to use a laminated film being prepared by further forming a thin layer on either one face or each face of the shaped polymer film with a gravure coater or the like.

The polymer film can contain other components such as a plasticizer, a stabilizer, a residual solvent, an antistatic agent, and an ultraviolet absorber as necessary within a scope of purposes of the present invention. Further, a leveling agent can be added so as to reduce surface roughness. For these purposes, the agents are preferable to be compatible with resins.

The polymer film can have a thickness in a range selected depending on a designed retardation and stretching properties, expression properties of the retardation, and the like. For example, the thickness is preferably in a range of 10˜500 μm and more preferably in a range of 10˜200 μm. Within these ranges, the film obtains adequate self-supporting properties and a wide range of retardation.

The polymer film preferably has a light transmittance of 85% or more at a wavelength of 590 nm, and more preferably that of 90% or more so as to reduce influences on luminance and contrast of liquid crystal display devices. The polymer film preferably has a haze of 2% or less, and more preferably that of 1% or less. An obtained retardation film also preferably has the same light transmittance and haze. The light transmittance and the haze are measured with an integrating sphere-type hazemeter compliant with JIS K 7105.

The polymer film preferably has a glass-transition temperature (Tg) of 110˜200° C. That is, with Tg of 110° C. or more, it is easy to obtain a film having a high durability. With Tg of 200° C. or less, it is easy to control an in-plane retardation and a retardation in a thickness direction by stretching The polymer film more preferably has Tg of 120˜195° C., and most preferably that of 130˜195° C. Tg is a value obtained by a DSC method compliant with JIS K 7121.

The polymer film is preferably made of a thermoplastic resin having a birefringence value (Δn) of 0.001 or more when the film undergoes a free-end uniaxially stretching at a stretch ratio of 2.0 at (Tg+10)° C. [Herein, Δn=nx−ny, “nx” indicating the refractive index in the direction of slow axis and “ny” indicating the refractive index in the direction of fast axis.] Specifically, in order to achieve “nx>nz>ny” (“nz” indicates the refractive index in the thickness direction) using materials having a low orientation, i.e., Δn of less than 0.001, there is such a problem that it is necessary to excessively increase a sagging ratio. Further, in order to achieve a desired retardation using such materials having a low orientation, there is also such a problem that a retardation film is liable to have a thickness lacking in uniformity because it is necessary to excessively increase a thickness of the polymer film.

The retardation film produced in this invention has the optical axis in the transverse direction perpendicular to the conveying direction of the polymer film and has the optical properties satisfying 0.1≦NZ≦0.9. “NZ” satisfies more preferably 0.2≦NZ≦0.8, yet more preferably 0.3≦NZ≦0.7, still more preferably 0.4≦NZ≦0.6, and most preferably 0.45≦NZ≦0.55. It is necessary to timely design the NZ value by a driving method of liquid crystal display devices and a compensation method of optical properties, but the value of 0.5 extremely improves visibility of liquid crystal display.

The in-plane retardation (Re) of the retardation film produced in this invention is not particularly limited, but the in-plane retardation with respect to light of a wavelength of 590 nm is preferably in a range of 40 nm≦Re≦2000 nm (nm: nanometer), more preferably in that of 100 nm≦Re≦350 nm or 400 nm≦Re≦700 nm, yet preferably in that of 120 nm≦Re≦200 nm, 240 nm≦Re≦300 nm, or 500 nm≦Re≦700 nm, and most preferably in that of 130 nm≦Re≦150 nm, 180 nm≦Re≦200 nm, 260 nm≦Re≦280 nm, or 600 nm≦Re≦700 nm. It is necessary to timely design the RE value by a driving method of liquid crystal display devices and a compensation method of optical properties, but the value in these ranges further improves visibility of liquid crystal display devices. “Re” is herein defined as follows.

Re=(nx−ny)×d

[“d (nm)” indicates a film thickness and “nx” and “ny” indicate the same meanings as those in the above-mentioned formula (1).]

In a preferred embodiment, the retardation film produced in this invention has an optical axis in the retardation film plane within ±1.0°. Specifically, the optical axis measured at 5 cm intervals in a film-width direction varies preferably in a range within ±1.0°, more preferably in that within ±0.7°, yet preferably in that within ±0.5°, and most preferably in that within ±0.3°. Large variance of the optical axis might reduce a degree of polarization in a case of lamination on a polarizer or a polarization plate. Therefore, the smaller the variance of the optical axis is the better.

The retardation film produced in this invention has a thickness in a range selected depending on a designed retardation and stretching properties, expression properties of retardation, and the like, and preferably in a range of 5˜450 μm, more preferably in that of 5˜200 μm, and yet preferably in that of 5˜100 μm. Within these ranges, the film obtains adequate self-supporting properties and a wide range of retardation.

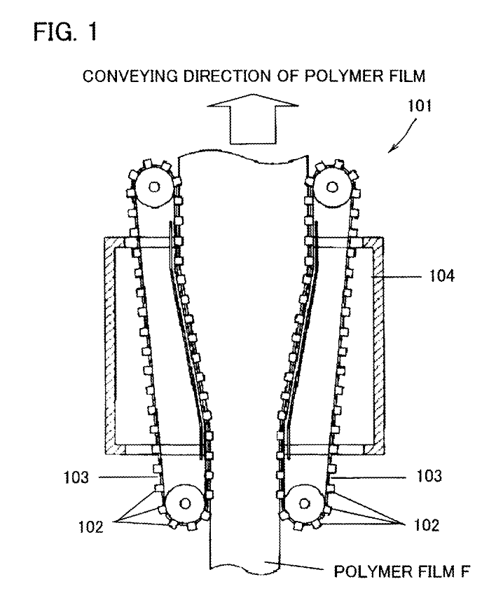

By the method in this invention, a long polymer film continuously fed is conveyed while the both side edges of the polymer film are held and stretched in the transverse direction perpendicular to the conveying direction while being conveyed. A film stretching machine for use in stretching a polymer film is not particularly limited and can use the conventional one. FIG. 1 shows an example of an available film stretching machine A film stretching machine 101 shown in FIG. 1 includes holding members 102 for holding the both side edges of a polymer film F, tenter chains 103 provided with the holding members 102 arranged at regular intervals, and a heating furnace 104 for heating the film F held with the tenter chains 103 by heated air and widens the intervals of the tenter chains 103 holding the film F, so as to stretch the film F in the transverse direction.

The conditions such as a preset temperature, a line speed, a stretching ratio, and a scaling pattern in stretching of the film F are determined at one's discretion and can be set so that the film F is best suited according to the physical properties of the film F and a target optical property.

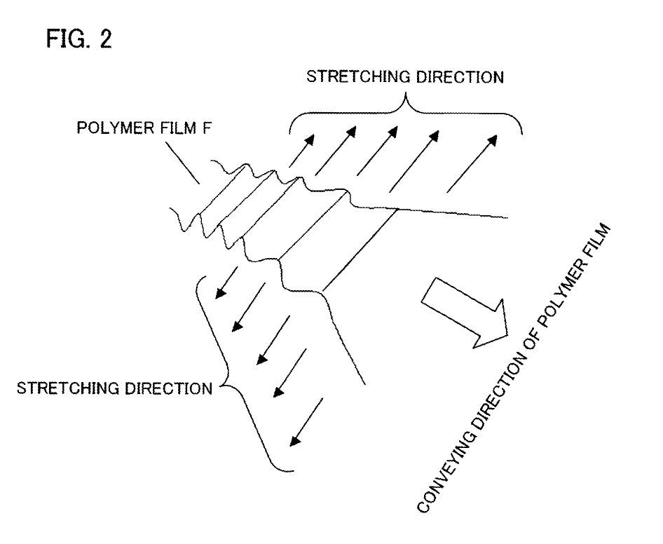

Further, by the method in this invention, the polymer film is stretched in the transverse direction with sagged in the conveying direction. A method for sagging the film in the conveying direction is not particularly limited, and for example, includes a method such as a means of feeding a film excessively with a pinch roller. FIG. 2 schematically shows the polymer film stretched in the transverse direction with sagged in the conveying direction.

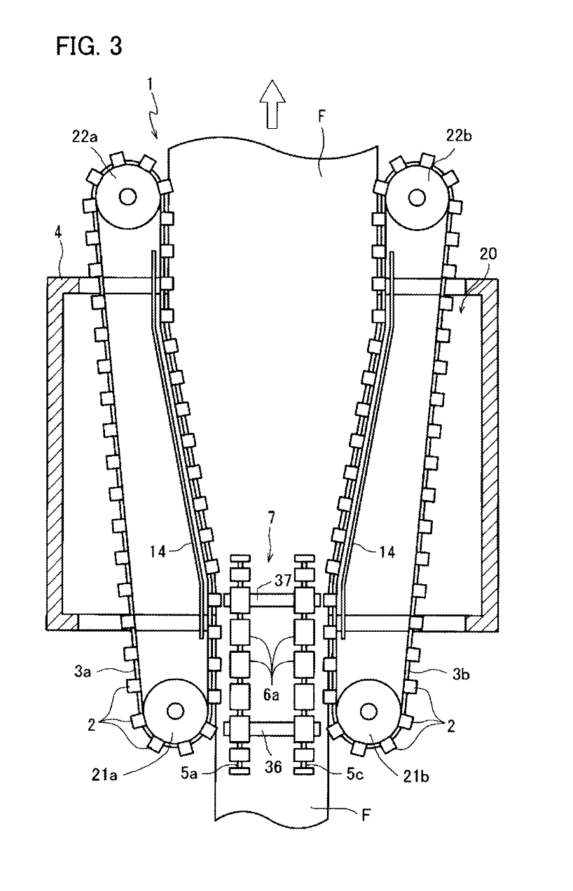

A preferred embodiment includes a step of sagging the both side edges of the polymer film with members having projections and recesses and a stretching step of stretching the sagged polymer film in the transverse direction. A more preferred embodiment further includes a holding step of holding the both side edges of the sagged polymer film on a conveyor and, in the above-mentioned stretching step, the polymer film is increased in width in a direction transverse to the conveying direction while being conveyed by the conveyor. More specifically, this embodiment is designed to convey the long polymer film continuously fed while holding the both side edges of the polymer film and stretch the polymer film in the direction transverse to the conveying direction while conveying the polymer film, and includes the following three steps, that is, the step of sagging the both side edges of the polymer film with the members having the projections and recesses, the holding step of holding the both side edges of the sagged film is on the conveyor, and the stretching step of stretching the polymer film in the transverse direction by increasing the width of the polymer film in the direction transverse to the conveying direction while conveying the polymer film by the conveyor. Also in these embodiments, common film stretching machines can be used, but the use of the film stretching machine having a configuration shown in FIGS. 3 to 13 produces a retardation film more effectively. Now, an example of producing a retardation film using a film stretching machine 1 in FIG. 3 will be described in detail below. However, naturally, it is not indispensable to use the film stretching machine 1 in FIG. 3 in the present invention.

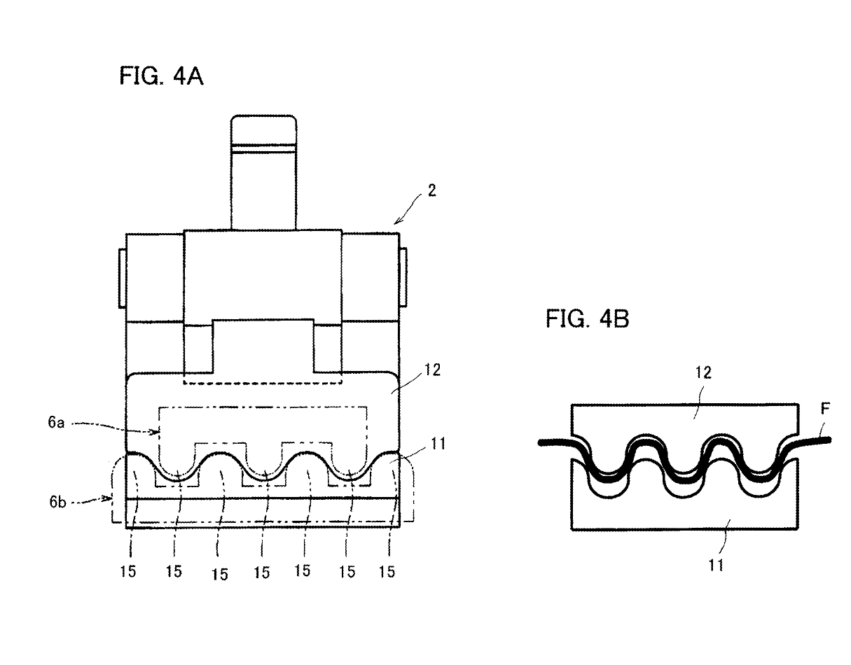

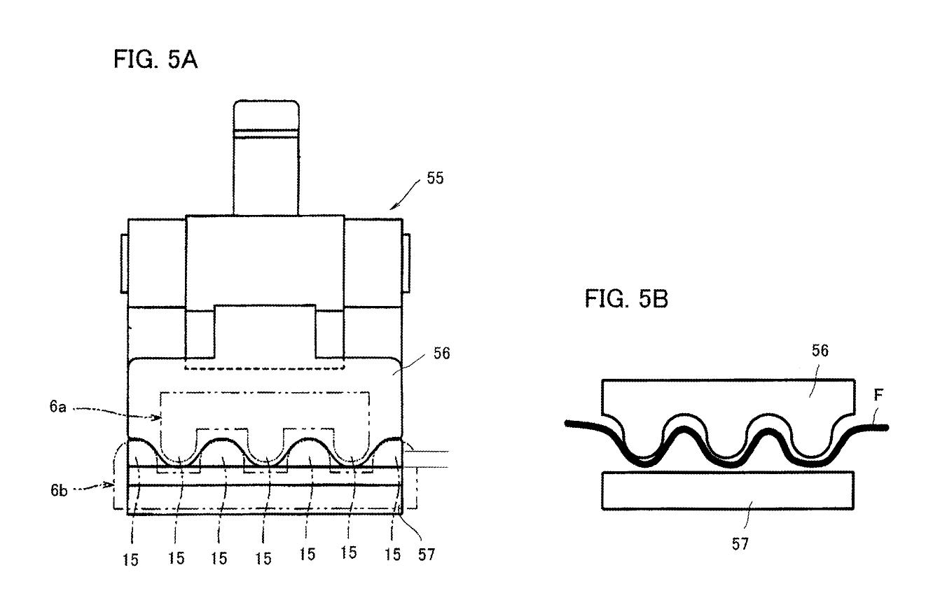

The film stretching machine 1 shown in FIG. 3 has paired tenter chains 3 provided with evenly spaced holding members 2 to hold both side edges of a polymer film F and a heating furnace 4 which heats the polymer film F held with the tenter chains 3 by hot blast, and is designed to stretch the polymer film F in the transverse direction by increasing the distance between the tenter chains 3 holding the film F. Herein, as described below, holding members 55 shown in FIGS. 5A and 5B can be employed instead of the holding members 2 shown in FIGS. 3, 4A, and 4B.

In a basic concept, the present embodiment is to stretch the polymer film F in the direction transverse to the conveying direction while keeping the film F shaped in a wavy form by holding the film F with the specifically shaped holding members 2, 55 provided in the film stretching machine 1, so that the film F is prevented from being stretched in the conveying direction while being stretched in the transverse direction, and thereby producing the film F stretched only in the transverse direction selectively.

Besides, the present embodiment is characterized in continuously carrying out, in order to realize the above-mentioned stretching operation continuously and smoothly, a step of feeding the film F, a step of continuously shaping the film F into a wavy form along the conveying direction, a step of holding the both side edges of the film F shaped in a wavy form on the conveyor, and a step of stretching the film F in the transverse direction while conveying the film F.

One preferable mode of each of the holding members 2 for stretching the polymer film F in the direction transverse to the conveying direction while keeping the film F shaped in a wavy form is a clip of projections and recesses with upper teeth and lower teeth of the holding member 2 which can engage. The use of the clip with this structure enables to form the film F into a wavy form and to stretch the film F in the direction transverse to the conveying direction while maintaining that state. The pitch and the size of the projections and recesses which will bite the film F are selected optionally depending upon the physical properties and the stretching ratio of the film F.

One example of the above-mentioned clip-type holding member 2 is illustrated in FIGS. 4A and 4B. Faces of the holding member 2 for pinching the film F are composed of a corrugated upper teeth part (holding member piece) 12 and a corrugated lower teeth part (holding member piece) 11, the both parts 11 and 12 being engaged with each other. The film F held with such the clip is shaped into a wavy form, thereby achieving the object of the present invention.

Another preferable mode of the holding member for stretching the film F in the direction transverse to the conveying direction while keeping the film F shaped in a wavy form is a clip having such a structure, as shown in FIGS. 5A and 5B, that the holding member 55 has holding member pieces 56 and 57, one of which is of a projections and recesses and the other of which is planar. The clip with this structure is preferable because it enables to stretch the film F while shaping the film F into a wavy form with a discretionary height or pitch. Besides, the use of an apparatus for continuously shaping the film F into a wavy form, such as a film overfeeding apparatus described below, is the most preferable embodiment because it is possible to certainly pinch an edge of the film F even if the wavy form of the shaped film F has nonconstant pitch and/or height.

A top face of the faces of the holding member 55 which pinch the film F is an upper teeth part (holding member piece) 56 having a wavy projections and recesses, while a bottom face thereof is a flat plane 57. With the film F, which is shaped in a wavy form by an apparatus such as the film-overfeeding apparatus described below, held by using such the clip, the film F is stretched in the transverse direction while maintaining the wavy form.

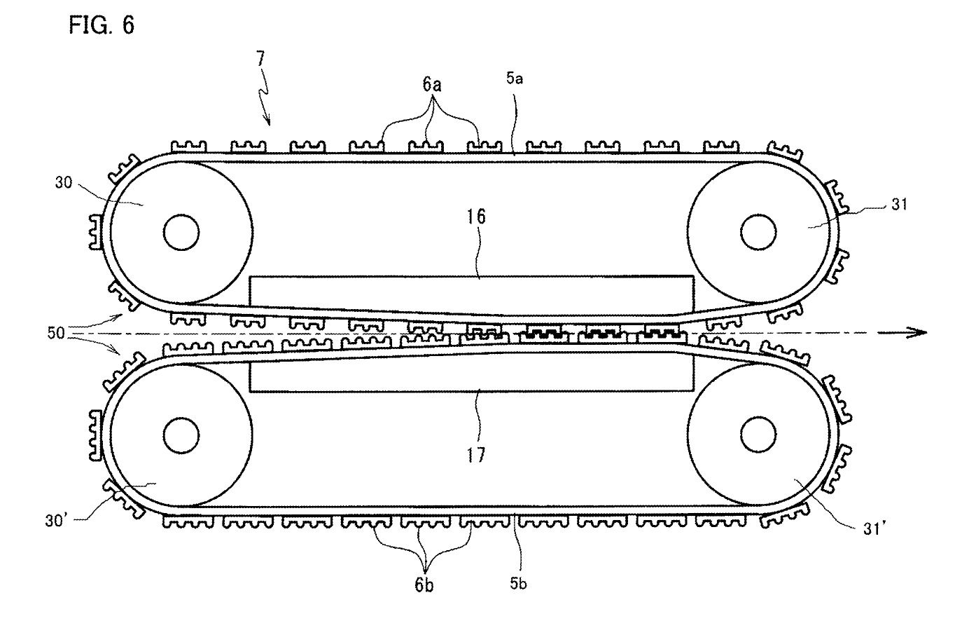

The film stretching machine 1 used in the present embodiment incorporates an apparatus for shaping the polymer film F into a wavy form continuously along the conveying direction. This apparatus is not particularly limited with respect to its structure as long as being an apparatus shaping the film F into a wavy form continuously along the conveying direction. For example, a film-overfeeding apparatus 7 as shown in FIGS. 6 and 7 is preferable because it does not apply unreasonable friction or tension to the film F and can smoothly shape a wavy form.

This film-overfeeding apparatus 7 has corrugated gripping members (a front gripping piece and a back gripping piece) 6a and 6b disposed oppositely on the front side and the back side of the film F so as to pinch the film F while moving in the conveying direction of the film F. The corrugated gripping members 6 are arranged in the conveying direction of the film F and have overfeeding projections 15 alternately projecting.

The corrugated gripping members (the front gripping piece and the back gripping piece) 6a and 6b of the film-overfeeding apparatus 7 are fixed to links of upper and lower feeder chains 5, respectively, at equal intervals. The corrugated gripping members (the front gripping piece and the back gripping piece) 6a and 6b are provided with the overfeeding projections 15. The overfeeding projections 15 project toward the film F in a staggered configuration at pitches equal to the pitches of the wavy form of the lower teeth part 11 and the upper teeth part 12 of the clip 2 in the conveying direction of the film F so as to extend in the width direction of the film F (i.e., perpendicular to the conveying direction). The corrugated gripping members (the front and back gripping pieces) 6a and 6b are configured to engage with each other when the upper and lower feeder chains 5 are made approach each other by feeder guides 16 and 17.

The corrugated gripping members (the front and back gripping pieces) 6a and 6b do not come into contact with each other and engage with each other so as to keep a clearance sufficiently larger than the thickness of the film F even when having approached the closest so as to mutually receive their overfeeding projections 15. This configuration prevents an excessive compression stress from acting to the center portion of the film F and thereby damaging it.

The overfeeding projections 15 are for sagging the whole area of the film F in a longitudinal direction in advance by pushing a face of the film F at intervals in the conveying direction.

In the film-overfeeding apparatus 7 to be used for the present invention, a plurality of above-mentioned corrugated gripping members (front and back gripping pieces) 6a and 6b may be provided at equal intervals to annular endless members rotating in a plane perpendicular to the conveyance plane of the film F.

The height, the width, the shape, and the pitch of the alternately projecting overfeeding projections 15 of the corrugated gripping members 6, the speed at which the upper and lower overfeeding projections 15 approach, and so on may be chosen freely depending upon the length necessary for shrinking the film F, the minimum bending radius for avoiding the damage of the film F, and the like.

In the film stretching machine 1 composed of the above configuration, the corrugated gripping members 6a and 6b of the film-overfeeding apparatus 7 firstly pinch the film F gradually from the upper and lower sides before the clips 2 hold the film F. That is, the overfeeding projections 15 push the faces of the film F gradually.

The clips 2 are designed to hold the both side edges of the film F with the holding members 2 while the film-overfeeding apparatus 7 is pinching the film F by making the corrugated gripping members 6a, and 6b approach.

Although the positions at which the film F is pinched with the corrugated gripping members 6 from the upper and lower sides are discretionary, it is necessary to pinch the film F inside from the edges of the film F. This is because it is necessary to make the conveyor hold the edges of the wave-formed film F while maintaining the wavy form of the film F. As to specific positions at which the film F is pinched, it is preferable to pinch the film F at positions 5 mm or more inside from the both side edges because interference with the holding members (clips) 2 may occur if the positions are too close to the side edges of the film F. From the viewpoint of fixing the film F to the clips 2 certainly, it is more preferable to pinch the film F at positions 10 mm or more inside from the both side edges. On the other hand, the positions where the film F is pinched from the upper and lower sides are preferably located within 20 mm from the both side edges because if the positions are excessively far away from the both side edges of the film F, the wavy form of the part to be pinched with the holding members (clips) 2 would be loosely shaped and waste of the film F would be caused.

As to an apparatus for stretching the film F in the transverse direction while conveying the film, any conventional stretching apparatus can be used without specific limitations. It is common and suitable for the present embodiment to be provided with two pairs of chains being made to pass through a tenter furnace (heating furnace 4), being mounted with the above-mentioned devices for fixing the both side edges of the film F to the chains, and being increased in the distance between the chains as the chains move.

The conditions such as a preset temperature, a stretching ratio, a scaling pattern, and a line speed in stretching of the polymer film F are determined at one's discretion and can be set so that the film F is best suited according to the physical properties and a target optical property of the polymer film F.

Next, a specific structure of the film stretching machine 1 used for the present embodiment will be described below.

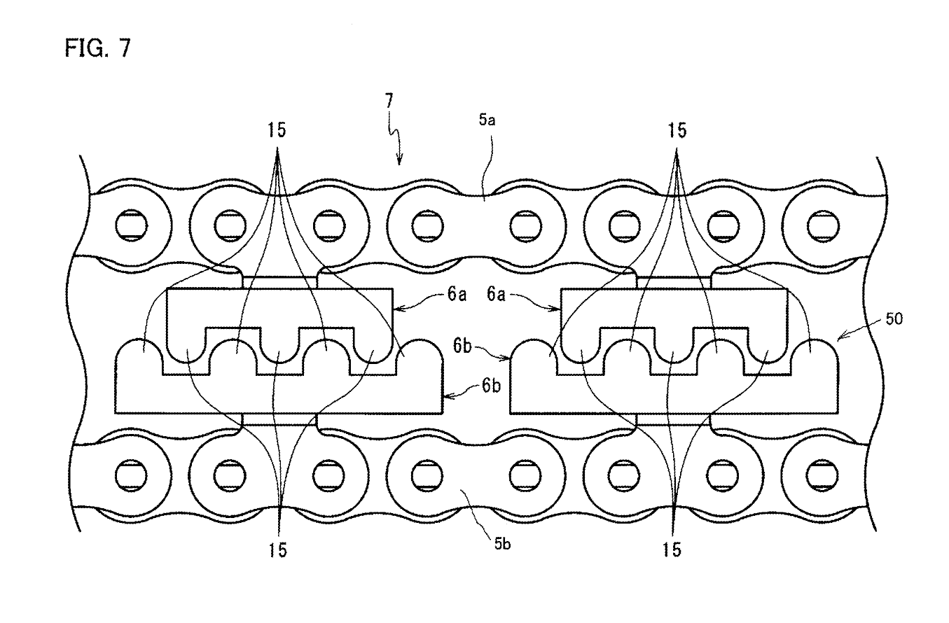

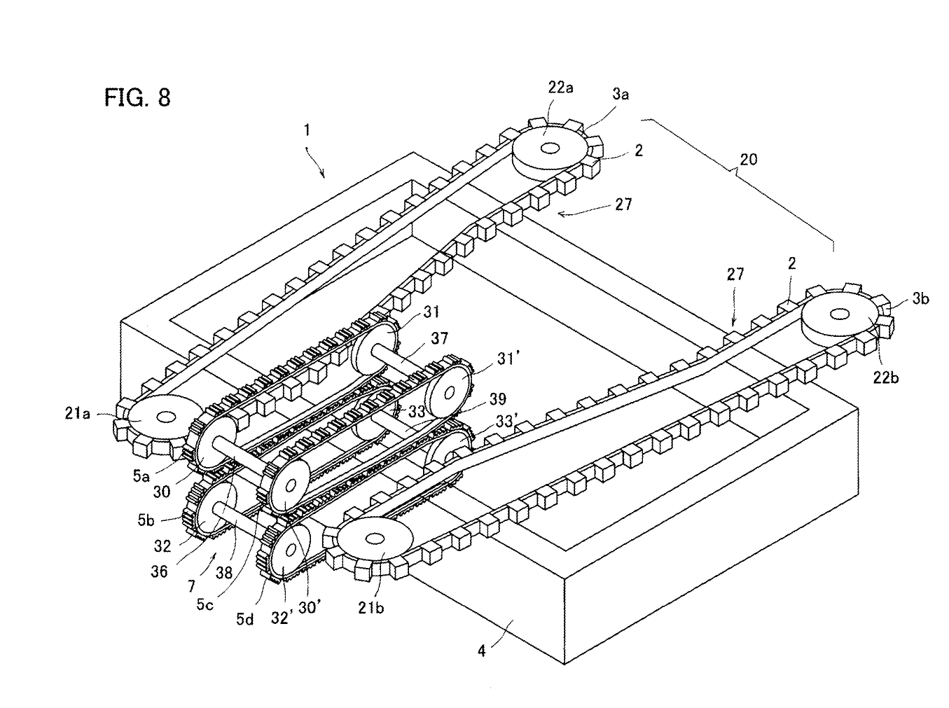

The film stretching machine 1 shown in FIG. 8 is mainly composed of a film stretching part 20, the heating furnace 4 (the length of the furnace and the number of zones of the furnace are discretionary), and the film-overfeeding apparatus 7.

The film stretching part 20 has the two series of tenter chains 3a and 3b and the clips 2 mounted to the tenter chains 3a and 3b at equal intervals for holding the both side edges of the film F.

The tenter chains 3a and 3b are respectively suspended on driving sprockets 21a and 21b and driven sprockets 22a and 22b.

The four sprockets 21a, 21b, 22a, and 22b on which the tenter chains 3a and 3b are suspended are all arranged on the same plane as shown in FIG. 8. In an description based on FIG. 8, the four sprockets 21a, 21b, 22a, and 22b on which the tenter chains 3a and 3b are suspended each have a rotational axis in a vertical direction and are arranged on a plane.

The two series of tenter chains 3a and 3b are arranged with one traveling surface of one chain opposed to one traveling surface of the other chain as shown in FIG. 8. The opposite traveling surfaces of the two series of tenter chains 3a and 3b work as stretching action parts 27.

The clips (holding members) 2 are mounted to the tenter chains 3a and 3b at equal intervals, thereby holding the both side edges of the film F.

The shape of the clips 2 will be described later.

The heating furnace 4 is to heat the film F held by the tenter chains 3a and 3b by hot blast.

Next, the film-overfeeding apparatus 7 will be described below.

The film-overfeeding apparatus 7 is mainly composed of two pairs (four series) of feeder chains 5a, 5b, 5c, and 5d.

As to the feeder chains 5a, 5b, 5c, and 5d, the feeder chains 5a and 5b form a pair and the feeder chains 5c and 5d form another pair as shown in FIG. 8.

Four sprockets 30, 31, 32, and 33 on which the pair of feeder chains 5a and 5b is suspended are arranged on the same plane as shown in FIG. 8. The plane constituted by the four sprockets 30, 31, 32, and 33 is a plane perpendicular to the plane constituted by the four sprockets 21a, 21b, 22a, and 22b on which the tenter chains 3a and 3b are suspended.

Of the four sprockets 30, 31, 32, and 33, the sprockets 30 and 32 are driving sprockets and the sprockets 31 and 33 are driven sprockets.

The other pair of feeder chains 5c and 5d is disposed in parallel with the feeder chains 5a and 5b.

The sprockets 30, 31, 32, and 33 contained in one pair are interconnected with the corresponding sprockets 30′, 31′, 32′, and 33′ contained in the other pair by common shafts 36, 37, 38, and 39 respectively. Therefore, the sprockets 30, 31, 32, and 33 synchronously rotate and the feeder chains 5c and 5d also synchronously run.

Of the two pairs (four series) of feeder chains 5a, 5b, 5c, and 5d, to the feeder chains 5a and 5c located on the upper side in FIG. 8 are mounted a plurality of front gripping pieces 6a at equal intervals, while to the feeder chains 5b and 5d located on the lower side in FIG. 8 are mounted a plurality of back gripping pieces 6b at equal intervals.

The front gripping pieces 6a mounted to the upper feeder chains 5a and 5c and the back gripping pieces 6b mounted to the lower feeder chains 5b and 5d are coupled to constitute the corrugated gripping members 6. The shapes of the front gripping pieces 6a and the back gripping pieces 6b will be described later.

The two pairs (four series) of feeder chains 5a, 5b, 5c, and 5d are located in the area substantially surrounded by the tenter chains 3a and 3b of the film stretching part 20.

The length of the feeder chains 5a, 5b, 5c, and 5d of the film-overfeeding apparatus 7, which is the distance between the shafts of the sprockets, is shorter than that of the tenter chains 3a, and 3b of the film stretching part 20.

The beginning portions of the feeder chains 5a, 5b, 5c, and 5d of the film-overfeeding apparatus 7 are located slightly upstream of the beginning portions of the tenter chains 3a, and 3b of the film stretching part 20, and the ending portions of the feeder chains 5a, 5b, 5c, and 5d are located at the ending portion of an introduction-side linear part.

The feeder chains 5a, 5b, 5c, and 5d of the film-overfeeding apparatus 7 and the tenter chains 3a and 3b run synchronously.

The heating furnace 4 is disposed at a position of a film-stretched portion of the film F widened by the tenter chains 3a and 3b in the film stretching part 20.

Next, the clips (holding members) 2 mounted to the tenter chains 3a and 3b are described in detail below.

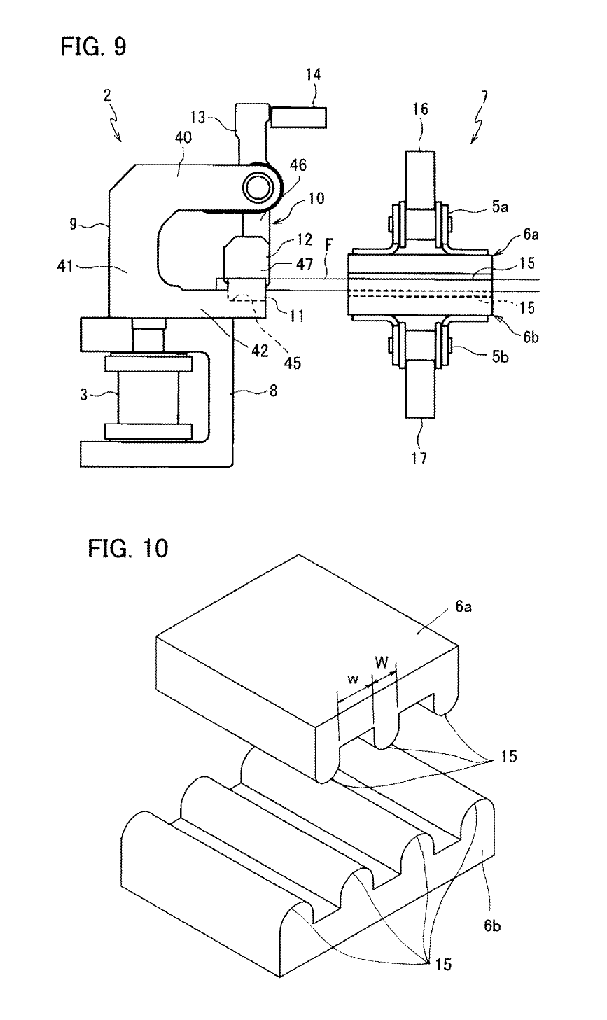

The clips 2 each are mounted to the tenter chain 3 through a base 8 as shown in FIG. 9. Specifically, the base 8 is fixed to a pin of the tenter chain 3 by a conventional means and the clip 2 is placed on the base 8.

Referring to FIG. 9, the clip 2 has a frame 9 of an approximate C-shape opening toward the polymer film F, to which frame 9 a flapper 10 is mounted.

Specifically, the frame 9 is of the C-shape having a top side 40, a vertical side 41, and a lower side 42. The top face (inner surface) of the lower side 42 of the frame 9 functions as a film placing face 45 and has a wavy form (lower teeth part 11) in this embodiment. That is, the film placing face 45, which is a holding member piece, has a wavy form with projections and recesses. In other words, the film placing face 45 is provided with the projections at predetermined intervals.

The flapper 10 has a rod part 46 and a pushing part 47. The middle part of the rod part 46 is pivoted to the top side 40 of the frame 9, so as to swing like a pendulum. The swinging direction of the flapper 10 is the width direction of the polymer film F. That is, the pushing part 47 of the flapper 10 moves while drawing an arc path. Thus, when the flapper 10 swings and the rod part 46 is in an inclined posture, the pushing part 47 separates from the film placing face 45. On the other hand, when the rod part 46 is a droopy posture, the bottom face of the pushing part 47 approaches the film placing face 45, thereby pushing the film placing face 45.

In the flapper 10 of this embodiment, the bottom face of the pushing part 47 has a wavy form (upper teeth part 12). That is, the pushing part 47, which is a holding member piece, also has a wavy form with projections and recesses. In other words, the pushing part 47 is also provided with the projecting parts at predetermined intervals.

When the rod part 46 comes in a droopy posture, the wavy form of the bottom face of the pushing part 47 (upper teeth part 12) and the wavy form of the film placing face 45 (lower teeth part 11) coincide.

Since the flapper 10 is so configured that the middle part of the rod part 46 is pivoted to the top side of the frame 9 as described above, the top end of the rod part 46 projects above the top side 40 of the frame 9.

Therefore, pushing of the top end of the rod part 46 in the transverse direction enables the flapper 10 to swing and the pushing part 47 of the flapper 10 to move close to and away from the film placing face 45 as described above.

In this embodiment, the tenter chains 3a and 3b each are provided with a long clip guide 14 adjacent thereto, with which guide 14 the top ends of the rod parts are kept in contact. The positional relationship between the clip guide 14 and the frame 9 is designed to vary position by position, and the flapper 10 is swung by pushing the top end of the rod part 46 with the clip guide 14.

FIG. 9 shows the details of the clip 2 holding the polymer film F and the corrugated gripping member 6. The clip 2 has the frame 9 fixed to one of the bases 8 mounted to the links of the tenter chain 3 at equal intervals and having an approximate C-shape opening toward the polymer film F, and the flapper 10 swingably pivoted at the tip of the top side of the frame 9. The flapper 10 has at its tip the upper teeth part 12 to be engaged with the lower teeth part 11 provided at the tip of the lower side of the frame 9. The flapper 10 is configured so that an arm part 13 extending above the frame is guided by the clip guide 14 to swing. The clip 2 holds or releases a side edge of the polymer film F with the lower teeth part 11 and the upper teeth part 12 in association with the swings of the flapper 10.

As shown in FIG. 9, the lower teeth part 11 and the upper teeth part 12 of the clip 2 are configured to engage with each other in a wavy form which rises and descends periodically at predetermined pitches in the conveying direction of the polymer film F.

Next, the front gripping pieces 6a and the back gripping pieces 6b mounted to the feeder chains 5a, 5b, 5c, and 5d are described in detail below.

As described above, the four feeder chains 5a, 5b, 5c, and 5d are arranged with divided into two pairs (5a and 5b) and (5c and 5d), and the feeder chains of each pair (5a and 5b) (5c and 5d) are disposed at the upper side and the lower side. FIG. 6 shows a pair of feeder chains 5a and 5b. FIG. 7, enlarging a part of FIG. 6, shows the corrugated gripping member 6 constituted by the front gripping piece 6a and the back gripping piece 6b.

In this embodiment, the opposite traveling surfaces of the feeder chains 5a and 5b (or 5c and 5d) function as feeding action parts 50 as shown in FIG. 6.

In this embodiment, the feeder guide 16 is provided in the traveling path on the side of the feeding action part 50 in an area surrounded by the feeder chain 5a located on the upper side. The feeder guide 16 has a length extending over the approximately whole area of the traveling path on the side of the feeding action part 50. The feeder guide 16 has a form with a middle part of the traveling path projecting outward (to the lower side based on the figure). More specifically, the feeder guide 16 has a guide face inclining gently with the vicinity of the end of the traveling path projecting outward.

Likewise, the feeder chain 5b located on the lower side is also provided with the feeder guide 17. The feeder guide 17 has a guide face inclining gently with the vicinity of the end of the traveling path projecting outward.

In this embodiment, the front gripping pieces 6a are mounted to the feeder chain 5a located on the upper side and the back gripping pieces 6b are mounted to the feeder chain 5b located on the lower side.

Each of the front gripping pieces 6a mounted to the feeder chain 5a is provided with the three overfeeding projections 15 on the bottom face as shown in FIG. 10.

The overfeeding projections 15 each project toward the polymer film F and have a rib-like form with a length along its crest. In short, each overfeeding projection 15 extends over the overall width of the front gripping piece 6a. The direction of the crest of the overfeeding projection 15 is along the width direction of the film F.

Portions without the overfeeding projections 15, i.e., portions of “valleys” between the overfeeding projections 15, are flat. The width W of the overfeeding projection 15 is smaller than the interval w between adjoining overfeeding projections 15.

The front gripping piece 6a can be said to be so configured that the overfeeding projections 15 are formed at predetermined intervals. Although being constant as a recommended configuration in this embodiment, the intervals between the overfeeding projections 15 may be uneven. The same can be applied to the back gripping piece 6b described later.

In addition, the bottom face of the front gripping piece 6a may be a corrugated face like a sine curve.

In this embodiment, a plurality of front gripping pieces 6a are provided at equal intervals to the feeder chain 5a located on the upper side. Also from this respect, the front gripping piece 6a can be said to be so configured that the overfeeding projections 15 are formed at predetermined intervals.

The intervals between the front gripping pieces 6a are equal to the intervals of the clips 2.

The back gripping pieces 6b mounted to the feeder chain 5b located on the lower side are also provided with the overfeeding projections 15.

The back gripping piece 6b also can be said to be so configured that the overfeeding projections 15 are formed at predetermined intervals.

The shape and the intervals of the overfeeding projections 15 mounted to the back gripping piece 6b located on the lower side are the same as those of the front gripping piece 6a described previously. However, the front gripping piece 6a has three overfeeding projections 15, whereas the back gripping piece 6b on the lower side has four overfeeding projections 15.

In this embodiment, a plurality of back gripping pieces 6b are provided at equal intervals to the feeder chain 5b located on the lower side.

Also from this respect, the back gripping piece 6b can be said to be so configured that the overfeeding projections 15 are formed at predetermined intervals.

The intervals between the back gripping pieces 6b are equal to the intervals of the front gripping pieces 6a described above.

The feeder chain 5a located on the upper side and the feeder chain 5b located on the lower side run synchronously, and the axial center of the front gripping piece 6a and that of the back gripping piece 6b always coincide in the traveling surfaces (feeding action parts) 50 in which the chains 5a and 5b oppose each other.

Since the feeder chains 5a and 5b are provided with the feeder guides 16 and 17 respectively, as described previously, so that the traveling paths of the feeder chains 5a and 5b project outward at their centers, the relative distance between the front gripping piece 6a and the back gripping piece 6b varies according to the traveling position of the feeder chains 5a and 5b.

Specifically, since both the feeder guides 16 and 17 project outwardly the ends of the feeding action parts 50 of the feeder chains 5a and 5b, the front gripping piece 6a and the back gripping piece 6b approach the closest when coming to the ends of the feeding action parts 50 of the feeder chains 5a and 5b.

On the other hand, at the beginnings of the feeding action parts 50, the clearance between the front gripping piece 6a and the back gripping piece 6b is open.

Therefore, when the feeder chains 5a and 5b have traveled and the front gripping piece 6a and the back gripping piece 6b have gone around to reach the side of the feeding action parts 50 (the opposing traveling surfaces), the front gripping piece 6a and the back gripping piece 6b face each other and then travel in the feeding action parts 50 while keeping their opposing posture.

At the beginnings of the feeding action parts 50, the clearance between the front gripping piece 6a and the back gripping piece 6b is open widely.

Specifically, the crests of the front gripping piece 6a and the crests of the back gripping piece 6b are separated vertically from each other. As the pieces travel in the feeding action parts 50, the clearance between them decreases, so that the crests of the front gripping piece 6a and the crests of the back gripping piece 6b engage with each other.

As the pieces travel in the feeding action parts 50, the clearance between them further decreases, so that the front gripping piece 6a and the back gripping piece 6b push surfaces of the polymer film F. Since the front gripping piece 6a and the back gripping piece 6b have the overfeeding projections 15 at staggered positions, for example, a counterforce generated when the tips of the overfeeding projections 15 on the front gripping piece 6a pushes a surface of the film F toward the lower side of the figure is held by the overfeeding projections 15 of the back gripping piece 6b located at an opposite position.

Therefore, the film F is shaped into a wavy form only in portions pinched by the corrugated gripping members 6 without moving up or down as a whole.

As described above, since the front gripping piece 6a and the back gripping piece 6b can be said to be so configured that the overfeeding projections 15 are formed at predetermined intervals, it can also be considered that the front and the back surfaces of the film F are pushed at intervals in the conveying direction. As a consequence, only the portions having been pinched by the corrugated gripping members 6 sag to be shaped into a wavy form.

Since the front gripping piece 6a and the back gripping piece 6b gradually approach as the feeder chains 5a, 5b run, the polymer film F is resultantly pinched gradually between the front gripping piece 6a and the back gripping piece 6b.

When having reached adjacent to the ends of the feeding action parts 50, the front gripping piece 6a and the back gripping piece 6b approach the closest.

When having reached adjacent to the ends of the feeding action parts 50, the front and back gripping pieces 6a and 6b come into an engaging posture, but the front and back gripping pieces 6a and 6b do not come into contact.

To describe more specifically, even when the front and back gripping pieces 6a and 6b approach the closest, the crests of the front gripping piece 6a never come into contact with the valleys of the back gripping piece 6b and the valleys of the front gripping piece 6a never come into contact with the crests of the back gripping piece 6b.

Besides, since the width W of the overfeeding projection 15 is smaller than the interval w between adjoining overfeeding projections 15, there is no possibility that the overfeeding projection 15 of the front gripping piece 6a and the overfeeding projection 15 of the back gripping piece 6b come into contact with each other although forming a nest state.

The tenter chains 3 and the feeder chains 5 are designed to rotate at the same circumferential speed, and the clips 2 and the corrugated gripping members 6a and 6b are provided at equal intervals so as to come to the same position in the conveying direction of the film F when holding or pinching the film F. The overfeeding projections 15 of the corrugated gripping members 6a and 6b are formed so as to correspond in number to the peaks of the wavy forms of the lower teeth part 11 and the upper teeth part 12 of the clip 2, respectively.

Next, the action of the film stretching machine 1 used in this embodiment will be described in detail below.

First, since the polymer film F is pinched between the corrugated gripping members 6a and 6b of the film-overfeeding apparatus 7, so as to be pushed by the overfeeding projections 15 in a staggered configuration from both sides, and thereafter a wavy form with the overfeeding projections 15 as peaks is formed. That is, the film sags. At this time, since the film F needs to have an excess length for corrugation, the film-overfeeding apparatus 7 resultantly pull in the film F from the upstream side at a speed (e.g., 1.2 times, i.e. 18 m/sec) higher than the conveying speed of the feeder chains 5 (e.g., 15 m/sec).

It is preferable that the conveying speed of the film-overfeeding apparatus 7 is higher than the conveying speed of the feeder chains 5 as described above, and an appropriate speed range is 1.05 times to 1.50 times the conveying speed of the feeder chains 5.

When the film-overfeeding apparatus 7 pulls in the film F from the upstream side, the film F resultantly scrapes the overfeeding projections 15. Therefore, it is preferable that the overfeeding projections 15 are made of a material such that the friction with the film is reduced. The overfeeding projections 15 may be substituted with rollers being independently rotatable.

It is ideal that the length of the polymer film F pinched between the corrugated gripping members 6a and 6b agree precisely with the length of the engaged form of the lower teeth part 11 and the upper teeth part 12 of the clip 2. However, if the film F would be fed excessively than the holding form of the clip 2, the clip 2 might form a wrinkle in the film F. In this embodiment, the length of the film F pinched between the corrugated gripping members 6a and 6b is adjusted so as to become slightly shorter than the length of the holding form of the clip 2. Therefore, the clip (holding member) 2 pulls in the film F from further upstream when holding the film F. However, since the length of the film F pulled in by the clip 2 is very small, there is no possibility that an excessive force is added to the clip guide 14 or the film F is damaged.

When the clips 2 have reached positions where they hold both side edges of the film F completely, the corrugated gripping members 6a and 6b separate from each other and release the film F.

The film stretching machine 1 conveys the polymer film F while corrugating and holding the film F with the clips (holding members) 2 also after the corrugated gripping members 6a and 6b of the film-overfeeding apparatus 7 have released the film F. That is, the film stretching machine 1 starts stretching in the transverse direction while keeping at least part of the film F sagged in the longitudinal direction in advance.

The film stretching machine 1 stretches the polymer film F in the width direction by extending the distance between the tenter chains 3 in the heating furnace 4.

Since each clip (holding member) 2 holds the polymer film F corrugated, the film stretching machine 1 makes a central effective part of the film F freely shrink in the longitudinal direction (conveying direction) and therefore no tensile stress generates in the longitudinal direction when stretching the film F in the width direction (e.g., to a stretching ratio of 1.2) in the heating furnace 4. This makes it possible to efficiently arrange the orientation axis of the film F (the orientation of molecular chains) in the width direction. In addition, since portions in the vicinities of the both side edges of the film F held with the clips 2 receive a stress in the longitudinal direction, these portions will be cut away in a post process.

The film-overfeeding apparatus 7 has the clips 2 for holding the side edge of the film F, which clips 2 each have the surfaces of both the pushing part 47 side and the film placing face 45 in a wavy form. That is, the preceding embodiments exemplifies the clip (holding member) 2 having the surfaces of both the pushing part 47 side and the film placing face 45 in a wavy form.

However, the clip 2 is not restricted to one having the surfaces of both the pushing part 47 side and the film placing face 45 in a wavy form, and may be have such a shape that only one part is of a wavy form or a teeth form and the other is of a planar form, like the above-mentioned holding member 55 shown in FIG. 5.

The embodiment described above employs the corrugated gripping member 6 composed of the front gripping piece 6a and the back gripping piece 6b as an apparatus for sagging and corrugating the polymer film F, so that the film F is shaped into a wavy form by pinching the film F with that member.

However, the present invention is not limited to this configuration and may employ a configuration of pinching the film F between a rack-like member and gear-like members using members having projections and recesses with a structure like a rack 58 and gears 59 as shown in FIG. 11, for example.

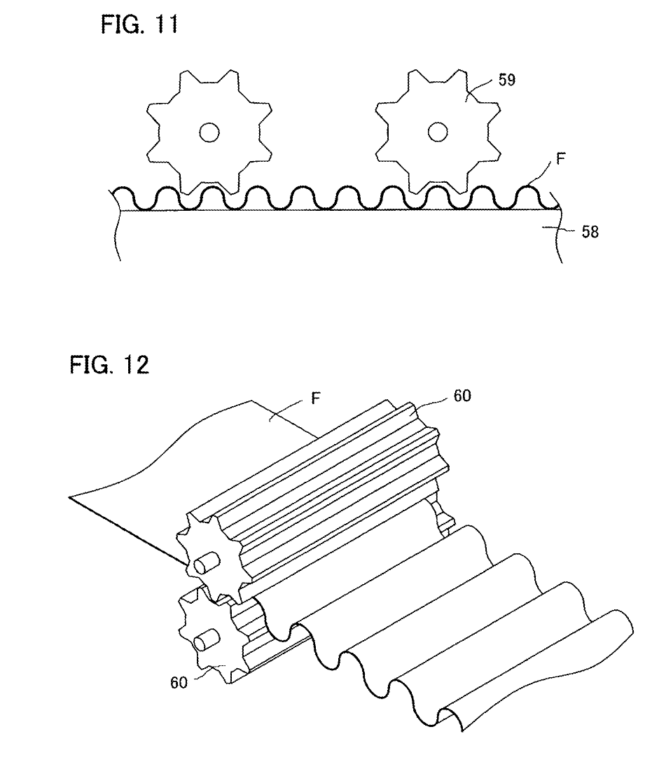

It is also permissible to employ a configuration of pinching the film F between two gear-like members (members having projections and recesses) 60 as shown in FIG. 12.

Also by embodiments of FIGS. 11 and 12, both surfaces of the polymer film F are pushed at intervals in the conveying direction, so that a partial area or the whole area of the film F is sagged in the longitudinal direction.

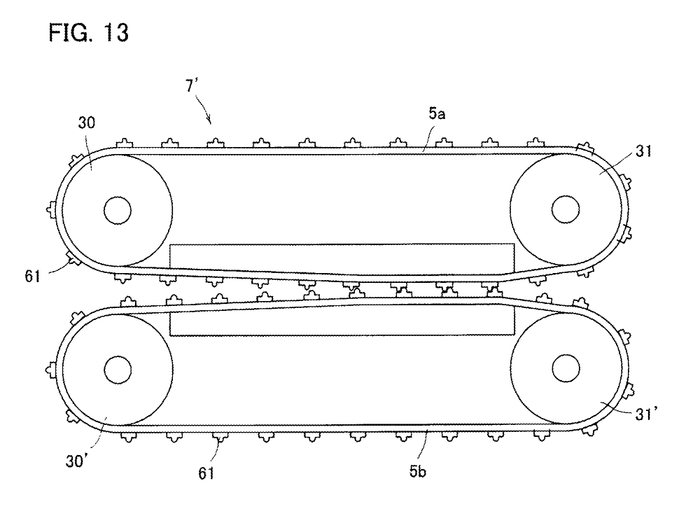

Although the embodiment described above employs a configuration in which the film-overfeeding apparatus 7 has the corrugated gripping members (the front gripping piece and the back gripping piece) 6a and 6b, which pinch the film F, it is also possible to provide, as shown in FIG. 13, blocks 61 each having only one projection, which blocks 61 push both surfaces of the film F. Also by the embodiment of FIG. 13, the both surfaces of the film F is pushed at intervals in the conveying direction, so that a partial area or the whole area of the film is sagged in the longitudinal direction.

The width of a retardation film after having been stretched can be optionally set by scaling the right and left tenter chains 3a and 3b of the film stretching machine 1, but the width is preferably 1000 mm or more, from the viewpoint of enlarged screens of liquid crystal display devices and efficiency of getting retardation films having a size in response to each screen size, more preferably 1200 mm or more, yet more preferably 1300 mm or more, and most preferably 1400 mm or more.

The description above is that of the embodiments using the film stretching machine 1 in FIG. 3.

By the method in this invention, a long polymer film can be one with a thermal shrinkable film laminated to at least one face thereof. For example, an original material with a thermal shrinkable film laminated to at least one face of a polymer film is used. The original material continuously fed is conveyed with its both side edges held, and is stretched in a direction transverse to the conveying direction while being conveyed. The film-stretching in the transverse direction is conducted while the film is heated in the heating furnace or the like. That achieves stretching in the transverse direction and simultaneously shrinkage of the thermal shrinkable film by heating, so as to provide desired properties to an obtained retardation film. It is discretionary to peel the thermal shrinkable film after the transverse stretching, but normally the thermal shrinkable film is peeled. A method of peeling at this time is not particularly limited and may be appropriately performed by using a peeling roll or the like.

A material of the thermal shrinkable film is not particularly limited as long as having properties such as shrink uniformity and heat resistance, and includes as an example polycarbonate, polyester, polypropylene, polystyrene, polyethylene, polyvinyl chloride, and polyvinylidene chloride.

A stretched film such as a uniaxially-stretched film and a biaxially-stretched film can be used as the thermal shrinkable film. In this invention, since the polymer film is stretched in the direction transverse to the conveying direction of the film, it is most preferable to use a vertically uniaxially-stretched film, which has small tensile load acting on the tenter chains and the clips in stretching.

The thermal shrinkable film can be obtained, for example, by stretching an unstretched film that is formed into a sheet by an extrusion method in a vertical direction and/or a transverse direction at a predetermined stretch ratio with a vertically uniaxial stretching machine, a simultaneous biaxial stretching machine or the like. Herein, conditions of forming and stretching are appropriately chosen depending on its purposes and compositions and kinds of used resin.

The thermal shrinkable film preferably has a shrinkage ratio in a longitudinal direction of the film of 4˜40%, more preferably of 7˜30%, particularly preferably of 10˜25%, and most preferably of 10˜20%. The shrinkage ratio can be determined by a method described in an example described later.

Further, a shrinkage ratio in a transverse direction of the thermal shrinkable film is not particularly limited since the polymer film is held with the clips in stretching, but is preferably of up to 30% for decrease of a tensile load acting on the tenter chains and the clips, more preferably of up to 25%, particularly preferably of up to 15%, and most preferably of up to 5%.

The thermal shrinkable film can appropriately and selectively employ a commercially available thermal shrinkable film used for a general package, a food package, a pallet wrapping, a shrink label, a cap sealing, an electrical insulating, and the like as long as satisfying the purpose of the present invention. These commercially available films may be used without modification or after additional processes such as a stretching process and a shrinking process.

A method of laminating the thermal shrinkable film is not particularly limited, but it is preferable to use a laminating method by providing a pressure-sensitive adhesive layer between the polymer film and the thermal shrinkable film in view of excellent productivity. The pressure-sensitive adhesive layer can be formed on either one or both of the polymer film and the thermal shrinkable film. Since the thermal shrinkable film is normally peeled after production of the above-mentioned retardation film, the pressure-sensitive adhesive is preferably excellent in adhesibility and heat resistance in a process of heating and stretching, and easily peeled in a peeling process thereafter so as not to be left on a surface of the retardation film. The pressure-sensitive adhesive layer is preferably provided on the thermal shrinkable film in view of high peelability.

There are an acrylic adhesive, a synthetic rubber adhesive, a rubber adhesive, a silicone adhesive, and so on as the pressure-sensitive adhesive forming the pressure-sensitive adhesive layer. It is preferable to use an acrylic pressure-sensitive adhesive containing acrylic polymer as a base polymer in view of high adhesibility, heat resistance, and peelability.

In contrast, it is also possible to employ an embodiment without the pressure-sensitive adhesive layer. For example, a laminated body constituted by lamination of a thermal shrinkable film on either one face or each face of a polymer film can be used as a long polymer film.

When such an original material constituted by the thermal shrinkable film laminated to at least one face of the polymer film is stretched in a transverse direction, stretching of the material with the material sagged in the conveying direction (see FIG. 2) is particularly preferable as a method for obtaining a retardation film having optical properties satisfying the above-mentioned formula (1) 0.1≦NZ≦0.9.

Since the side edges of the original material is held with the clips and the like by the method in this invention, the original material constituted by the thermal shrinkable film laminated to one face of the polymer film is prevented from being formed into a roll-like shape due to shrink of the thermal shrinkable film in the transverse direction as in the method described in Patent document 4 even when being stretched. The use of the original material constituted by the thermal shrinkable film laminated to one face of the polymer film in the present invention decreases use of the thermal shrinkable film by half and reduces a laminating process of the thermal shrinkable film, so as to be a particularly preferred embodiment largely contributing to reduction of production cost.

It is also possible to use the above-mentioned stretched polymer film such as a uniaxially-stretched film and a biaxially-stretched film as the thermal shrinkable film. In a case of use of these polymer films as the thermal shrinkable films, it is not necessary to peel them after stretching and is possible to use the film stayed laminated. Such an embodiment is particularly preferable since a setting range of optical properties such as Re, NZ, and wavelength dispersion (Re 400 nm˜800 nm/Re 550 nm) can be adjusted widely. It is particularly preferable to use as the thermal shrinkable film a polymer film composed of single application of or a combination of more than one of polycarbonate-based resins, norbornene-based resins, polyolefin-based resins, cellulose-based resins, urethane-based resins, styrene-based resins, polyimide-based resins, and polyamide-based resins.

Instead of the thermal shrinkable film, a rubber elastic body having heat resistance and tackiness of a material such as silicone rubber can be used by being laminated to a polymer film while being vertically uniaxially stretched. This kind of rubber elastic body returns to its original state if peeled after having been stretched in the transverse direction by the method of the present invention so as to have desired optical properties. Therefore, the elastic body is repeatedly used any number of times and this embodiment is a preferred embodiment largely contributing to reduction of production cost.

In the embodiments in which the polymer film on which the thermal shrinkable film laminated or the polymer film having thermal shrink properties is used, in some cases, the optical axis can be provided in the transverse direction without increasing of the width in the transverse direction. For example, thermal shrinkage generated by thermal load reduces sagging in the conveying direction (in a vertical direction) of a polymer film, so that a retardation film having an optical axis in the transverse direction is obtained even without the increasing of the width in the transverse direction, like maintaining or decreasing of a width of the polymer film. This invention includes such embodiments in “stretching in the transverse direction”.

Next, an optical film of the present invention will be described in detail below. The optical film in the present invention is produced by laminating polarizer directly or with a polarizer protection film on at least one face of either the retardation film in the present invention or the retardation film produced by the method for producing a retardation film in the present invention.

The polarizer employed in the optical film in the present invention is not particularly limited and may be of various kinds. For example, an absorption-type polarizing plate is preferably used, the plate being produced by laminating a transparent protection film to a polarizer having been cross-linked and dried after staining a polyvinyl alcohol (PVA) film with either dichroic iodine or dichroic dye and stretching the resulting film to orient. The polarizer is preferable to be excellent in a light transmittance and a degree of polarization. The light transmittance is preferably of 30˜50%, more preferably of 35˜50%, and most preferably of 40˜50%. The degree of polarization is preferably of 90% or more, more preferably of 95% or more, and most preferably of 99% or more. In case of the light transmittance of less than 30% or the degree of polarization of less than 90%, liquid crystal display devices may have low luminance and contrast and reduced visual quality. A thickness of the polarizer is preferably of 1˜50 μm, more preferably of 1˜30 μm, and most preferably of 8˜25 μm.

The polarizer is normally provided with a transparent protection film on its one face or each face. A laminating treatment of the polarizer and the transparent protection film in this invention can be performed without particular limitation but with, for example, an adhesive agent composed of vinyl alcohol-series polymer or an adhesive agent composed of at least soluble cross-linking agent, such as boric acid, borax, glutaraldehyde, melamine, and oxalic agent, for vinyl alcohol-series polymer. In particular, it is preferable to use a polyvinyl alcohol-series polymer in the point of its best adhesion performance with a polyvinyl alcohol-series film. Such an adhesive layer can be formed as a dried layer on which an aqueous solution is applied, and the aqueous solution can be prepared by dispensing other additives and catalyst such as acid as needed.

A material forming the transparent protection film includes, in view of transparency, thermal stability, and strength, cellulose-based resins such as diacetyl cellulose and triacetyl cellulose, polyester-based resins such as polyethylene terephthalate and polyethylene naphthalate, acrylic-based resins such as polymethylmethacrylate, styrene-based resins such as polystyrene, acrylonitrile styrene copolymer, styrene resin, acrylonitrile styrene resin, acrylonitrile butadiene styrene resin, acrylonitrile ethylene styrene resin, styrene maleimide copolymer, and styrene-maleic anhydride copolymer, and polycarbonate-based resins, for example. Further, a resin forming the transparent protection film includes also cycloolefin-based resins, norbornene-based resins, polyolefin-based resins such as polyethylene, polypropylene, and ethylene propylene copolymer, vinyl chloride-based resins, amide-based resins such as nylon and aromatic polyamide, imide-based resins such as aromatic polyimide and polyimide-amide, sulfone-based resins, polyether sulfone-based resins, polyether ether ketone-based resins, polyphenylene sulfide-based resins, vinyl alcohol-based resins, vinylidene chloride-based resins, vinyl butyral-based resins, arylate-based resins, polyoxymethylene-based resins, epoxy-based resins, and a polymer film composed of a combination of the above-mentioned resins or the like. Still further, the transparent protection film can be formed as a hardened layer made of thermoset or ultraviolet cure resin such as acrylic series, urethane series, acrylic urethane series, epoxy series, and silicone series. In particular, cellulose-based resins, norbornene-based resins, and cycloolefin-based resins are preferable in view of transparency and thermal stability.

Next, an image display device in the present invention will be described in detail below. The image display device in the present invention is provided with the retardation film in this invention, the retardation film produced by the method for producing a retardation film in this invention, or the optical film in this invention.

A type of the image display device in the present invention is not particularly limited and includes a liquid crystal display, an organic electroluminescence (organic EL) display, a plasma display, a projector, and a projection television as an example.

In particular, a liquid crystal display varies in display performance depending on an angle to see an image. The retardation film in this invention is preferably used in particular since having a function of compensation for the variances in display performance caused depending on an angle to see it. A type of liquid crystal display is not particularly limited and may be used in any forms of a transmission type, a reflection type, and a reflection-transmission type. A liquid crystal cell used in the liquid crystal display includes various kinds thereof such as a liquid crystal cell of twisted nematic (TN) mode, of super-twisted nematic (STN) mode, of vertical alignment (VA) mode, of in-plane switching (IPS) mode, of horizontal alignment (ECB) mode, of fringe field switching (FSS) mode, of bend nematic (OCB) mode, of hybrid orientation (HAN) mode, of ferroelectric liquid crystal (SSFLC) mode, of antiferroelectric liquid crystal (AFLC) mode, or the like. In particular, the retardation film and the optical film in this invention are preferably used in combination with a liquid crystal cell of TN mode, of VA mode, of IPS mode, of OCB mode, of FSS mode, or of OCB mode among those. The retardation film and the optical film in this invention are most preferably used in combination with a liquid crystal cell of IPS mode or of VA mode.

Next, a liquid crystal display device in the present invention will be described in detail below. The liquid crystal display device in the present invention is provided with the optical film in this invention.

A type of liquid crystal display in the present invention is not particularly limited and may be used in any forms of a transmission type, a reflection type, and a reflection-transmission type as an example A liquid crystal cell used in the liquid crystal display device includes various kinds thereof such as a liquid crystal cell of twisted nematic (TN) mode, of super-twisted nematic (STN) mode, of vertical alignment (VA) mode, of in-plane switching (IPS) mode, of horizontal alignment (ECB) mode, of fringe field switching (FSS) mode, of bend nematic (OCB) mode, of hybrid orientation (HAN) mode, of ferroelectric liquid crystal (SSFLC) mode, of antiferroelectric liquid crystal (AFLC) mode, or the like. In particular, the retardation film and the optical film in this invention are preferably used in combination with a liquid crystal cell of TN mode, of VA mode, of IPS mode, of OCB mode, of FSS mode, or of OCB mode among those. The retardation film and the optical film in this invention are most preferably used in combination with a liquid crystal cell of IPS mode or of VA mode.

### EXAMPLES

The present invention will be described specifically below with reference to examples and comparative examples, but the examples do not limit the invention.

Herein, measuring methods of various kinds of physical properties and optical properties employed in the examples are as follows.

(1) Retardation (Re), NZ measurement, Optical axis

The measurements of those were conducted with an Automatic Birefringence Analyzer KOBRA-WR produced by Oji Scientific Instruments at a wavelength of 590 nm and at 5 cm intervals in a width direction. NZ measurement was conducted at an inclination angle of 45°. The Re value and the NZ value were shown by using respective average values. The optical axis was shown by using a variance range.

(2) Thickness

The thickness in the width direction was measured with a Thickness Testers of contacting type KG601A produced by Anritsu Corp. at 1 mm intervals. The thickness was shown by using an obtained average value.

(3) Shrinkage ratio of a thermal shrinkable film [1] (Examples 1-1 to 1-8, Comparative Examples 1-1 to 1-3, Examples 3-1 to 3-3)

The measurements were conducted in compliance with “Method A for heat shrinkage ratio” of JIS Z 1712. As to a heating temperature, the measurements were conducted at 125° C. for polyethylene (PE), at 150° C. for polypropylene (PP), and at 170° C. for polycarbonate (PC) with a test specimen being subjected to weight bearing of 5 g. More specifically, test specimens were prepared by taking five pieces of specimens each having a width of 20 mm and a length of 300 mm from a longitudinal direction (MD), each of which pieces has reference points on either side of a center part at a distance of 200 mm. The test specimens were vertically hung in an air-circulating constant temperature oven maintained at a set temperature ±3° C. with being subjected to weight bearing of 5 g. After heating of 20 minutes, the specimens were taken out from the oven and left in a constant temperature and humidity room (23° C./50% RH) for 30 minutes. The shrinkage ratio was calculated by measuring distances between the reference points with a vernier caliper standard for JIS B 7507, averaging the five measured values, and plugging into a formula: 100×[(distance between reference points before heating)−(distance between reference points after heating)]/distance between reference points before heating.

(4) Shrinkage ratio of a thermal shrinkable film [2] (Examples 2-1 to 2-12, Comparative Examples 2-1 to 2-4)

The measurements were conducted in compliance with “Method A for heat shrinkage ratio” of JIS Z 1712. As to a heating temperature, the measurements were conducted at 125° C. for polyethylene (PE) and at 160° C. for others with a test specimen being subjected to weight bearing of 3 g. More specifically, test specimens were prepared by taking five pieces of specimens each having a width of 20 mm and a length of 150 mm from a longitudinal direction (MD), each of which pieces has reference points on either side of a center part at a distance of 100 mm. The test specimens were vertically hung in an air-circulating constant temperature oven maintained at a set temperature·3° C. with being subjected to weight bearing of 3 g. After heating of 15 minutes, the specimens were taken out from the oven and left in a constant temperature and humidity room (23° C./50% RH) for 30 minutes. The shrinkage ratio was calculated by measuring distances between the reference points with a vernier caliper standard for JIS B 7507, averaging the five measured values, and plugging into a formula: 100·[(distance between reference points before heating)−(distance between reference points after heating)]/(distance between reference points before heating).

(5) Visibility of Liquid Crystal Display Device

The visibility was evaluated by using a polarizer and a liquid crystal display device described below. The evaluation was shown as follows from a contrast ratio in an oblique direction.

∘: Excellent in contrast on the left, right, top, and bottom

x: Inferior in contrast due to leaking light

<Polarizer>

A polyvinyl alcohol film having a thickness of 80 m was uniaxially stretched sixfold continuously in iodine solution and dried, thereby preparing a polarizer having a thickness of 20 m. The obtained polarizer had a sufficient light transmittance and degree of polarization.

<Liquid Crystal Display Device>

A liquid crystal display device (TH-32LN80 produced by Panasonic) containing IPS mode liquid crystal cells was used. A liquid crystal panel was taken out from the liquid crystal display device, so as to be used after removing polarization plates arranged at top and bottom of the panel and washing its glass face (both faces).

<Contrast Measurement>

Y values of XYZ indicator system were measured at angles of direction of 45°, 135°, 225°, and 315° with turning the angles from 0° to 360° in a direction of polar angle of 60° in cases of displaying a white image and a black image by using EZ Contrast 160D (produced by ELDIM) 30 minutes after turning on a backlight in a dark room (23° C.). The contrast ratios in an oblique direction “YW/YB”, “YW (white luminance)” being a Y value in the white image and “YB (black luminance)” being a Y value in the black image, were calculated and an average value of the contrast ratios in the oblique direction at the angles of direction 45°, 135°, 225°, and 315° was obtained.

(5) Birefringence Value (Δn) of Polymer Film

A value “Δn” was measured at a wavelength of 590 nm by using an Automatic Refractometer KOBRA-WR produced by Oji Scientific Instruments) after a free-end uniaxial stretching at a stretch ratio of 2.0 under a condition of glass-transition temperature (Tg)+10° C. of each polymer film.

### Example 1-1

A thermal shrinkable film was laminated to each face of a polycarbonate (PC) film (“ELMECH R-film unstretched” of Δn=0.043 produced by Kaneka Corp.) having a width of 1250 mm and a thickness of 65 m via an acrylic pressure-sensitive adhesive (product name: Transfer Adhesive NCF-102, produced by Lintec Corp., having a thickness of 25 m, an adhesibility to glass of 10 N/25 mm, and a transmittance of 99.4%). The thermal shrinkable film used herein was a uniaxial-stretching high-density polyethylene film (product name: Hiblon FMK, produced by Tokyo Printing Ink, having a thickness of 25 m and a shrinkage ratio of 16% and indicated as “A” in Table 1). By using the clips shown in FIG. 5, the film stretching machine shown in FIG. 8, and the film-overfeeding apparatus shown in FIGS. 6, 7, and 9, the film was held at its both side edges with sagged by 13% in the conveying direction, and was stretched by 8% in a direction transverse to the conveying direction at 140° C.

### Example 1-2

A thermal shrinkable film used herein was a uniaxial-stretching polypropylene (PP) film (product name: Noblen ASS, produced by Tokyo Printing Ink, having a thickness of 25 m and a shrinkage ratio of 19% and indicated as “B” in Table 1). The film was stretched in the transverse direction in the same manner as Example 1-1 except that the film was stretched by 10% at 155° C. with sagged by 15%.

### Example 1-3

A thermal shrinkable film used herein was a uniaxial-stretching PP film (product name: Noblen KST2W, produced by Tokyo Printing Ink, having a thickness of 60 m and a shrinkage ratio of 27% and indicated as “C” in Table 1). The film was stretched in the transverse direction in the same manner as Example 1-2 except that the film was stretched with sagged by 12%.

### Example 1-4

The film was stretched in the transverse direction in the same manner as Example 1-3 except that the thermal shrinkable film was laminated to one face of the PC film.

### Example 1-5

The film was stretched in the transverse direction in the same manner as Example 1-3 except that the film was stretched by 12% at 160° C. with sagged by 20%.

### Example 1-6

The film was stretched in the transverse direction in the same manner as Example 1-5 except that the film was stretched by 20% with sagged by 25%.

### Example 1-7

A thermal shrinkable film used herein was a uniaxial-stretching PC film (product name: ELMECH R-film #570, produced by Kaneka Corp., having a thickness of 55 m and a shrinkage ratio of 32% and indicated as “D” in Table 1). The film was stretched in the transverse direction in the same manner as Example 1-1 except that the film was stretched by 18% at 165° C. with sagged by 28%.

### Example 1-8

The film was stretched in the transverse direction in the same manner as Example 1-6 except that the PC film had a thickness of 35 m.

### Comparative Example 1-1

The film was stretched in the transverse direction in the same manner as Example 1-1 except that the film was sagged by 0% in the conveying direction.

### Comparative Example 1-2

The film was stretched in the transverse direction in the same manner as Example 1-6 except that the film was sagged by 0% in the conveying direction.

### Comparative Example 1-3

The film was stretched in the transverse direction in the same manner as Example 1-7 except that the film was sagged by 0% in the conveying direction.

Table 1 shows characteristics of the retardation films obtained in Examples 1-1 to 1-8 and the Comparative Examples 1-1 to 1-3. “Stretch ratio” in Table 1 indicates a stretch ratio of stretching in the transverse direction relative to a width of an original material. For example, in a case where an original material having a width of 1000 mm was stretched by 5% of a stretch ratio, a width after stretching is 1050 mm. Further, “Sagging ratio” in Table 1 indicates an amount of film sagged in the conveying direction. For example, in a case of a film having a length in the conveying direction of 4000 mm and a sagging ratio of 10%, the film was sagged by 400 mm.

TABLE 1

| | | Thermal | Stretching condition | | | Optical properties | | | | | |
|---|---|---|---|---|---|---|---|---|---|---|---|
| | Polymer | shrinkable | Temperature | Stretch ratio | Sagging | Re | | Optical axis | Light trans- | Haze | |
| | film | film | (° C.) | (%) | ratio (%) | (nm) | NZ | (°) | mittance (%) | (%) | Visibility |
| Example 1-1 | PC | A | 140 | 8 | 13 | 350 | 0.6 | ±0.7 | 91 | 0.5 | ◯ |
| Example 1-2 | 65 μm | B | 155 | 10 | 15 | 220 | 0.6 | ±0.5 | | | ◯ |
| Example 1-3 | | C | 155 | 10 | 12 | 200 | 0.7 | ±0.6 | | | ◯ |
| Example 1-4 | | | | | | 180 | 0.8 | ±0.7 | | | ◯ |
| Example 1-5 | | | 160 | 12 | 20 | 270 | 0.3 | ±0.6 | | | ◯ |
| Example 1-6 | | | 160 | 20 | 25 | 410 | 0.5 | ±0.3 | | | ◯ |
| Example 1-7 | | D | 165 | 18 | 28 | 340 | 0.3 | ±0.4 | | | ◯ |
| Example 1-8 | PC | C | 160 | 20 | 25 | 238 | 0.6 | ±0.3 | | | ◯ |
| | 35 μm | | | | | | | | | | |
| Comparative | PC | A | 140 | 8 | 0 | 300 | 2.1 | ±0.8 | 91 | 0.4 | X |
| Example 1-1 | 65 μm | | | | | | | | | | |
| Comparative | | C | 160 | 20 | 0 | 320 | 1.9 | ±0.7 | | | X |
| Example 1-2 | | | | | | | | | | | |
| Comparative | | D | 165 | 18 | 0 | 270 | 2.0 | ±0.7 | | | X |
| Example 1-3 | | | | | | | | | | | |

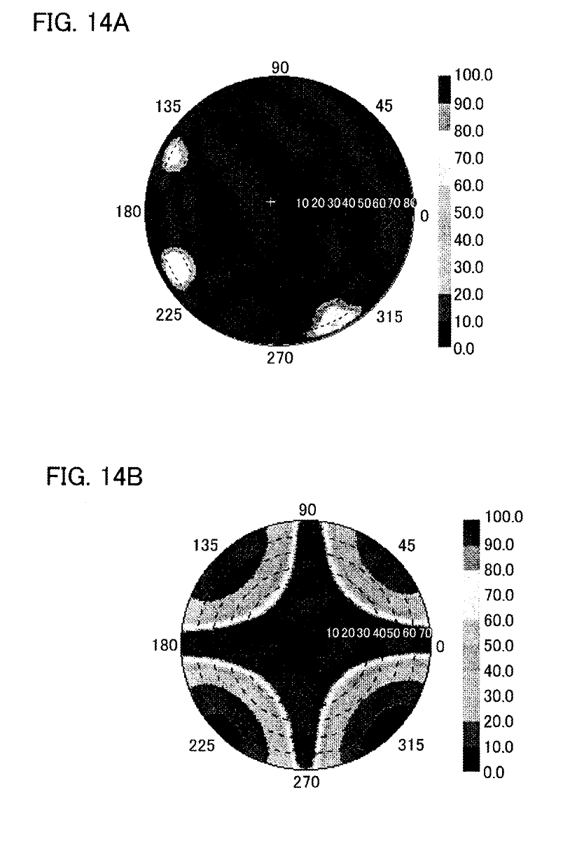

Table 2 shows results of contrast measurements (average values of contrast ratio in an oblique direction) of the retardation films obtained in Example 1-5 and the Comparative Example 1-3. “Stretch ratio” and “Sagging ratio” in Table 2 indicate the same meanings as those in Table 1. Further, FIGS. 14A and 14B show contrast cones of the retardation films obtained in Example 1-5 and the Comparative Example 1-3, respectively.

TABLE 2

Optical axis

| | 45° | 135° | 225° | 315° | Average |
|---|---|---|---|---|---|
| Example 1-5 | 200 | 119 | 156 | 207 | 171 |
| Comparative | 20 | 19 | 17 | 15 | 18 |
| Example 1-3 | | | | | |

As shown above, the retardation films obtained in Examples 1-1 to 1-8 were all excellent in visibility. In contrast, the retardation films obtained in the Comparative Examples 1-1 to 1-3 were all inferior in visibility.

In all the films obtained in Examples 1-1 to 1-8 and the Comparative Examples 1-1 to 1-3, the pressure-sensitive adhesives and the thermal shrinkable films are to be peeled after the transverse stretching

### Example 2-1

A PC thermal shrinkable film (10% of shrinkage ratio) was laminated to each face of a polycarbonate (PC) film (“ELMECH R-film unstretched” produced by Kaneka Corp.) having a thickness of 65 m via an acrylic pressure-sensitive adhesive (20 m of thickness). By using the film stretching machine, the film was held at its both side edges with sagged by 5% in the conveying direction, and was stretched by 2% in a direction transverse to the conveying direction in an air-circulating constant temperature oven at 152° C.·1° C.

### Example 2-2

The film was stretched in the transverse direction in the same manner as Example 2-1 except that the film was stretched by 20% at 145° C. with sagged by 25% in the conveying direction.

### Example 2-3

The film was stretched in the transverse direction in the same manner as Example 2-1 except that a thermal shrinkable film used herein was a polyethylene (PE) thermal shrinkable film having 11% of shrinkage ratio and that the film was stretched by 20% at 145° C. with sagged by 25% in the conveying direction.

### Example 2-4

The film was stretched in the transverse direction in the same manner as Example 2-1 except that a thermal shrinkable film used herein was a polypropylene (PP) thermal shrinkable film having 8% of shrinkage ratio and that the film was stretched by 4% at 139° C. with sagged by 10% in the conveying direction.

### Example 2-5

The film was stretched in the transverse direction in the same manner as Example 2-1 except that a thermal shrinkable film used herein was a PP thermal shrinkable film having 11% of shrinkage ratio and that the film was stretched by 8% at 143° C. with sagged by 15% in the conveying direction.

### Example 2-6

The film was stretched in the transverse direction in the same manner as Example 2-1 except that a thermal shrinkable film used herein was a PP thermal shrinkable film having 15% of shrinkage ratio and that the film was stretched by 20% at 148° C. with sagged by 29% in the conveying direction.

### Example 2-7

A PP thermal shrinkable film (20% of shrinkage ratio) was laminated to only one face of a PC film having a thickness of 65 m via an acrylic pressure-sensitive adhesive (20 m of thickness). The film was stretched in the transverse direction in the same manner as Example 2-1 except that the film was stretched by 20% at 148° C. with sagged by 25% in the conveying direction.

### Example 2-8

A PC thermal shrinkable film (10% of shrinkage ratio) was laminated to each face of a PC film (“ELMECH R-film unstretched” produced by Kaneka Corp.) having a thickness of 35 m via an acrylic pressure-sensitive adhesive (20 m of thickness). By using the film stretching machine, the film was held at its both side edges with sagged by 10% in the conveying direction, and was stretched by 6% in a direction transverse to the conveying direction in an air-circulating constant temperature oven at 152° C.·1° C.

### Example 2-9

The film was stretched in the transverse direction in the same manner as Example 2-8 except that a thermal shrinkable film used herein was a PE thermal shrinkable film having 11% of shrinkage ratio and that the film was stretched by 9% at 140° C. with sagged by 14% in the conveying direction.

### Example 2-10

The film was stretched in the transverse direction in the same manner as Example 2-8 except that a thermal shrinkable film used herein was a PE thermal shrinkable film having 15% of shrinkage ratio and that the film was stretched by 22% at 140° C. with sagged by 30% in the conveying direction.

### Example 2-11

The film was stretched in the transverse direction in the same manner as Example 2-8 except that a thermal shrinkable film used herein was a PP thermal shrinkable film having 15% of shrinkage ratio and that the film was stretched by 35% at 152° C. with sagged by 41% in the conveying direction.

### Example 2-12

A PP thermal shrinkable film (23% of shrinkage ratio) was laminated to only one face of a PC film (“ELMECH R-film unstretched” produced by Kaneka Corp.) having a thickness of 35 m via an acrylic pressure-sensitive adhesive (20 m of thickness). The film was stretched in the transverse direction in the same manner as Example 2-10 except that the film was stretched at 144° C.

### Comparative Example 2-1

The film was stretched in the transverse direction in the same manner as Example 2-4 except that the film was sagged by 0% in the conveying direction.

### Comparative Example 2-2

The film was stretched in the transverse direction in the same manner as Example 2-6 except that the film was sagged by 0% in the conveying direction.

### Comparative Example 2-3

The film was stretched in the transverse direction in the same manner as Example 2-10 except that the film was sagged by 0% in the conveying direction.

### Comparative Example 2-4

The film was stretched in the transverse direction in the same manner as Example 2-12 except that the film was sagged by 0% in the conveying direction.

Table 3 shows characteristics of the retardation films obtained in Examples 2-1 to 2-12 and the Comparative Examples 2-1 to 2-4. “Stretch Ratio” and “Sagging Ratio” in Table 3 indicate the same meanings as those in Table 1. The retardation films obtained in Examples 2-1 to 2-12 were all excellent in visibility. In contrast, the retardation films obtained in the Comparative Examples 2-1 to 2-4 were all inferior in visibility.

TABLE 3

| | | Shrinkable film | | Stretching condition | | | Optical properties | | | | | |
|---|---|---|---|---|---|---|---|---|---|---|---|---|
| | Polymer | | Shrinkage | Temperature | Stretch ratio | Sagging | Re | | Optical axis | Light trans- | Haze | |
| | film | Kind | ratio (%) | (° C.) | (%) | ratio (%) | (nm) | NZ | (°) | mittance (%) | (%) | Visibility |
| Example 2-1 | PC | PC | 10 | 152 | 2 | 5 | 142 | 0.8 | ±0.8 | 91 | 0.5 | ◯ |
| Example 2-2 | 65 μm | | | 145 | 20 | 25 | 674 | 0.6 | ±0.6 | | | ◯ |
| Example 2-3 | | PE | 11 | 145 | 20 | 25 | 685 | 0.5 | ±0.3 | | | ◯ |
| Example 2-4 | | PP | 8 | 139 | 4 | 10 | 273 | 0.5 | ±0.5 | | | ◯ |
| Example 2-5 | | | 11 | 143 | 8 | 15 | 451 | 0.3 | ±0.3 | | | ◯ |
| Example 2-6 | | | 15 | 148 | 20 | 29 | 680 | 0.2 | ±0.5 | | | ◯ |
| Example 2-7 | | | 20 | 148 | 20 | 25 | 670 | 0.5 | ±0.6 | | | ◯ |
| Example 2-8 | PC | PC | 10 | 152 | 6 | 10 | 145 | 0.7 | ±0.7 | 92 | 0.4 | ◯ |
| Example 2-9 | 35 μm | PE | 11 | 140 | 9 | 14 | 275 | 0.5 | ±0.5 | | | ◯ |
| Example 2-10 | | | 15 | 140 | 22 | 30 | 425 | 0.3 | ±0.3 | | | ◯ |
| Example 2-11 | | PP | 15 | 152 | 35 | 41 | 650 | 0.5 | ±0.3 | | | ◯ |
| Example 2-12 | | | 23 | 144 | 22 | 30 | 401 | 0.3 | ±0.4 | | | ◯ |
| Comparative | PC | PP | 8 | 139 | 4 | 0 | 201 | 2.1 | ±0.6 | 91 | 0.5 | X |
| Example 2-1 | 65 μm | | | | | | | | | | | |
| Comparative | | | 15 | 148 | 20 | 0 | 520 | 1.9 | ±0.5 | | | X |
| Example 2-2 | | | | | | | | | | | | |
| Comparative | PC | PE | 15 | 140 | 22 | 0 | 354 | 2.1 | ±0.5 | 92 | 0.4 | X |
| Example 2-3 | 35 μm | | | | | | | | | | | |
| Comparative | | PP | 23 | 144 | 22 | 0 | 331 | 2.0 | ±0.6 | | | X |
| Example 2-4 | | | | | | | | | | | | |

In all the films obtained in Examples 2-1 to 2-12 and the Comparative Examples 2-1 to 2-4, the pressure-sensitive adhesives and the thermal shrinkable films are to be peeled after the transverse stretching

### Example 3-1

A thermal shrinkable film was laminated to each face of a cycloolefin-based film (product name: Arton, produced by JSR Corp., having Δn=0.0065) having a film width of 1050 mm and a thickness of 130 m via an acrylic pressure-sensitive adhesive of the same kind as used in Example 1-1. The thermal shrinkable film used herein was of the same kind used in Example 1-3 (“C” in Table 1). The film was stretched in the transverse direction in the same manner as Example 1-1 except that the film was stretched by 20% at 150° C. with sagged by 20% in the conveying direction.

### Example 3-2

The film was stretched in the transverse direction in the same manner as Example 3-1 except that a polyamide-based film (T-714E, produced by Toyobo Co., Ltd., having Δn=0.011) having a film width of 1050 mm and a thickness of 150 m was used.

### Example 3-3

The film was stretched in the transverse direction in the same manner as Example 3-1 except that a polyester-urethane film (product name: Vylon, produced by Toyobo Co., Ltd., having Δn=0.001) having a film width of 1340 mm and a thickness of 150 m was used.

Table 4 shows optical properties of the retardation films obtained in Examples 3-1 to 3-3. “Stretch Ratio” and “Sagging Ratio” in Table 4 indicate the same meanings as those in Table 1. The retardation films obtained in Examples 3-1 to 3-3 were all excellent in visibility.

TABLE 4

| | Δn of | Thermal | Stretching condition | | | Optical properties | | | | | |
|---|---|---|---|---|---|---|---|---|---|---|---|
| | polymer | shrinkable | Temperature | Stretch ratio | Sagging | Re | | Optical axis | Light trans- | Haze | |
| | film | film | (° C.) | (%) | ratio (%) | (nm) | NZ | (°) | mittance (%) | (%) | Visibility |
| Example 3-1 | 0.0065 | C | 150 | 20 | 20 | 146 | 0.5 | ±0.6 | 92 | 0.4 | ◯ |
| Example 3-2 | 0.011 | | | | | 219 | 0.6 | ±0.7 | 90 | 0.5 | ◯ |
| Example 3-3 | 0.001 | | | | | 205 | 0.6 | ±0.6 | 92 | 0.4 | ◯ |

In all the films obtained in Examples 3-1 to 3-3, the pressure-sensitive adhesives and the thermal shrinkable films are to be peeled after the transverse stretching.

1. A method for producing a retardation film, comprising:
conveying a long polymer film being continuously fed in a conveying direction while holding both side edges of the polymer film; and
stretching the polymer film in a transverse direction being perpendicular to the conveying direction while conveying the polymer film,
wherein the retardation film has an optical axis in the transverse direction perpendicular to the conveying direction of the polymer film and has optical properties satisfying the following formula (1):
1≦NZ≦0.9 (1)
[NZ=(nx−nz)/(nx−ny), and
“nx” indicates the refractive index in a direction of slow axis of the retardation film, in which the direction of slow axis means a direction having the largest refractive index in a retardation film plane, while “ny” indicates the refractive index in a direction of fast axis of the retardation film, and while “nz” indicates the refractive index in a direction of thickness of the retardation film.],
wherein the polymer film is stretched in the transverse direction with sagged in the conveying direction, and
wherein the method includes a step of sagging the both side edges of the polymer film with members having projections and recesses and a stretching step of stretching the sagged polymer film in the transverse direction.

2. The method according to claim 1,
wherein the retardation film has an in-plane retardation (Re) with respect to light of a wavelength of 590 nm satisfying the following formula (2):
40 nm≦Re≦2000 (2)
[Re=(nx−ny)×d, and
“d (nm) indicates a thickness of the retardation film and “nx” and “ny” indicate the same meanings as those of the above-mentioned formula (1).].

3. The method according to claim 2,
wherein the retardation film has the optical axis in the retardation film plane within ±1.0°.

4. (canceled)

5. The method according to claim 1,
wherein the method further includes a holding step of holding the both side edges of the sagged polymer film on a conveyor, and
wherein, in the stretching step, the polymer film is increased in width in the direction transverse to the conveying direction while being conveyed by the conveyor.

6. The method according to claim 5,
starting to stretch the polymer film in the transverse direction with a partial area or the whole area of the polymer film sagged in the conveying direction while the both side edges of the polymer film are held with holding members provided with holding member pieces having projections and recesses.

7. The method according to claim 5,
starting to stretch the polymer film in the transverse direction with a partial area or the whole area of the polymer film sagged by pushing one face and the other face of the polymer film in an alternate arrangement.

8. The method according to claim 1,
wherein the polymer film is made of a thermoplastic resin having 0.001 or more of a birefringence rate (Δn) in free-end uniaxial stretching at a stretch ratio of 2.0 under the condition of (Tg+10)° C. (herein “Tg” denotes a glass-transition temperature (° C.) of the polymer film.).

9. The method according to claim 1,
wherein the polymer film is laminated with a thermal shrinkable film at either one face or each face of the polymer film.

10. The method according to claim 9,
wherein the thermal shrinkable film is peeled after stretching of the polymer film in the transverse direction.

11. An optical film being formed by laminating a polarizer directly or with a polarizer protection film on at least one face of the retardation film produced by the method according to claim 1.

12. An image display device comprising the retardation film produced by the method according to claim 1.

13. A liquid crystal display device comprising the optical film according to claim 11.

14-18. (canceled)

19. A method for producing a retardation film, comprising:
conveying a long polymer film being continuously fed in a conveying direction while holding both side edges of the polymer film; and
stretching the polymer film in a transverse direction being perpendicular to the conveying direction while conveying the polymer film,
wherein the retardation film has an optical axis in the transverse direction perpendicular to the conveying direction of the polymer film and has optical properties satisfying the following formula (1):
0.1≦NZ≦0.9 (1)
[NZ=(nx−nz)/(nx−ny), and
“nx” indicates the refractive index in a direction of slow axis of the retardation film, in which the direction of slow axis means a direction having the largest refractive index in a retardation film plane, while “ny” indicates the refractive index in a direction of fast axis of the retardation film, and while “nz” indicates the refractive index in a direction of thickness of the retardation film.], and
wherein the polymer film is stretched in the transverse direction with sagged in the conveying direction, and
the method starting to stretch the polymer film in the transverse direction with a partial area or the whole area of the polymer film sagged by pushing one face and the other face of the polymer film in an alternate arrangement.

20. The method according to claim 19,
wherein the retardation film has an in-plane retardation (Re) with respect to light of a wavelength of 590 nm satisfying the following formula (2):
40 nm≦Re≦2000 (2)
[Re=(nx−ny)×d, and
“d (nm) indicates a thickness of the polymer film and “nx” and “ny” indicate the same meanings as those of the above-mentioned formula (1).].

21. The method according to claim 20,
wherein the retardation film has the optical axis in the retardation film plane within ±1.0°.

22. The method according to claim 19,
wherein the polymer film is made of a thermoplastic resin having 0.001 or more of a birefringence rate (Δn) in free-end uniaxial stretching at a stretch ratio of 2.0 under the condition of (Tg+10)° C. (herein “Tg” denotes a glass-transition temperature (° C.) of the polymer film.).

23. The method according to claim 19,
wherein the polymer film is laminated with a thermal shrinkable film at either one face or each face of the polymer film.

24. The method according to claim 23,
wherein the thermal shrinkable film is peeled after stretching of the polymer film in the transverse direction.

25. An optical film being formed by laminating a polarizer directly or with a polarizer protection film on at least one face of the retardation film produced by the method according to claim 19.

26. An image display device comprising the retardation film produced by the method according to claim 19.

27. A liquid crystal display device comprising the optical film according to claim 25.
